(19) United States
(12) Patent Application Publication
(10) Pub. No.: US 2010/0116052 A1
(43) Pub. Date: May 13, 2010

(54) PIEZOELECTRIC VIBRATOR, AND VIBRATION GYRO

(75) Inventors: Tohru Yanagisawa, Tokyo (JP); Izumi Yamamoto, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: CITIZEN HOLDINGS CO., LTD., Nishitokyo-shi, Tokyo (JP)

(21) Appl. No.: 12/532,313

(22) PCT Filed: Mar. 19, 2008
(86) PCT No.: PCT/JP2008/055085

§ 371 Date: Sep. 21, 2009

(30) Foreign Application Priority Data
Mar. 20, 2007 (JP) 2007 072652

(51) Int. Cl. G01C 19/56

(52) U.S. Cl. 73/504.16

(57) ABSTRACT

At the frequency of natural vibration with which the driving tines and detection tine of a piezoelectric vibrator resonate, the vibration directions of natural vibrations and the frequency difference between the resonance frequencies are set to reduce the leakage of vibration from the driving tines to the detection tine for suppressing the leakage vibration of the piezoelectric vibrator. In the piezoelectric vibrator, the vibration direction of the driving tines is made orthogonal to the vibration direction of the detection tine, or the frequency difference between the resonance frequency of the driving tines in the in-plane direction and the resonance frequency of the driving tines in the out-of-plane direction is increased sufficiently to suppress the growth of the leakage vibration. This configuration makes the piezoelectric vibrator compact and reduces leakage vibrations.

### TECHNICAL FIELD

The present invention relates to a piezoelectric vibrator and a vibration gyro that uses a piezoelectric vibrator, and more particularly to a piezoelectric vibrator, which has a base and driving tines and detection tines extending from the base, and a vibration gyro that uses this piezoelectric vibrator.

### BACKGROUND ART

An oscillator that uses a piezoelectric vibrator, such as a crystal oscillator, is used in a wide range of fields, for example, in a clock used in the electronic/communication field or in various electronic devices used as the source of frequency such as the reference frequency. For example, using a piezoelectric vibrator as the angular velocity sensor, a vibration gyro may be configured that detects the angular velocity of a movable body by detecting a vibration generated by the Coriolis force proportional to the angular velocity. This vibration gyro is used for the reaction control or the navigation of movable bodies such as an aircraft and a train.

The configuration of a piezoelectric vibrator that the driving tines and the detection tines are extended in the opposite direction with respect to the base is known (see Patent Document 1). A piezoelectric vibrator 101 shown in FIG. 26A has the configuration in which a pair of driving tines 103a and 103b and a pair of detection tines 104a and 104b are extended in the opposite direction with respect to a base 102. In this piezoelectric vibrator 101, a pair of the driving tines 103a and 103b is vibrated in reverse phase to each other in the plane formed by the driving tines 103a and 103b, and the vibration induced in reverse phase to each other in a plane orthogonal to the plane described above through the Coriolis force, generated by the rotational angular velocity ω on the axis of symmetry of the piezoelectric vibrator, is detected by the detection tines 104a and 104b.

Because the driving tines and the detection tines are fixed on the base 102 in the configuration shown in FIG. 26A, the problem is that the center line of the base 102 tends to be twisted at the detection time with the result that the detection sensitivity low. To solve this problem, a configuration is proposed in which the number of driving tines or detection tines is increased. FIG. 26B shows an example in which the number of detection tines is increased. In the example of this configuration of a piezoelectric vibrator 111, driving tines 113a and 113b are provided in one direction with respect to a base 112, and detection tines 114a to 114d are provided in the direction opposite to the above-described direction of the base 112.

The configuration, in which the driving tines and the detection tines are extended in the opposite direction with respect to the base, has a problem that it is difficult to make the piezoelectric vibrator compact because both tines are extended in the opposite directions.

On the other hand, a still another configuration of a piezoelectric vibrator is known in which the driving tines and the detection tines are extended in one direction with respect to the base (see Patent Documents 2-4). FIG. 26C shows an example of the configuration of a piezoelectric vibrator 121 in which driving tines 123a and 123b and detection tines 124 are extended in one direction with respect to a base 122.

In a vibration gyro that uses a piezoelectric vibrator, when the angular velocity ω is applied around the axis on the driving vibration plane of the piezoelectric vibrator, the Coriolis force proportional to the angular velocity ω is generated in the direction orthogonal to the driving vibration direction. As a result, the piezoelectric vibrator has a vibration component in the direction orthogonal to the driving vibration direction. The vibration gyro detects the angular velocity ω by detecting the vibration component in the direction orthogonal to the driving vibration direction.

It is requested that the detection output be 0 when the angular velocity ω is 0; however, a vibration called a leakage vibration, which is generated in the detection direction due to the excitation of the driving tines, is sometimes generated. Ideally, the vibration component of the driving tines excited in the driving direction should be generated in the driving direction only, and the detuning degree Δf, which is the difference between the resonance frequency fd in the driving vibration mode and the resonance frequency fs in the detection mode, should be smaller in order to ensure higher detection sensitivity. In practice, however, a fabrication accuracy error or an internal or external coupling error in the piezoelectric vibrator generates a leakage vibration. Because this leakage vibration is increased as the detuning degree Δf is smaller, the value of the detuning degree Δf is set so that both the sensitivity and the magnitude of the leakage vibration are appropriate.

This leakage vibration decreases the detection output and the sensitivity. Conventionally, to prevent the detection output or sensitivity of a piezoelectric vibrator from being decreased, the detuning degree Δf is adjusted or the trimming for decreasing the leakage vibration is performed.

In the configuration examples in Patent Documents 2-4 described above, it is disclosed that the mass of the vibration tines is trimmed for adjustment. In Patent Document 2, a file, a rotor, or a laser is used to remove a part of the mass of the driving tines and, in Patent Document 3, the configuration in which abrasives are embedded on a tape is disclosed. In Patent Document 4, the use of multiple laser beams is disclosed.

Patent Document 1: Japanese Patent Laid-Open Publication No. Hei 11-14373

Patent Document 2: Japanese Patent Laid-Open Publication No. 2000-337880

Patent Document 3: Japanese Patent Laid-Open Publication No. 2002-243451

Patent Document 4: Japanese Patent Laid-Open Publication No. 2004-93158

### DISCLOSURE OF THE INVENTION

### Problems to be Solved by the Invention

As described above, the configuration in which the driving tines and the detection tines are extended in the opposite direction to each other with respect to the base has a problem that it is difficult to make the piezoelectric vibrator compact. On the other hand, the configuration in which the driving tines and the detection tines are extended in one direction with respect to the base solves the compactness problem but has a problem that the process of trimming the mass of the vibration tines is required, and this process requires time and costs.

The configuration of a piezoelectric vibrator in which the driving tines and the detection tines are extended in one direction with respect to the base also has a problem that, in the conventional driving mode, the output is generated by a leakage vibration even when the angular velocity is not applied. In addition, in the detection mode in which the angular velocity is detected by the Coriolis force, the detection output is affected by a vibration of the driving tines.

FIG. 27 and FIG. 28 are diagrams showing the driving mode of driving tines, the detection mode, and a leakage vibration. FIG. 27A and FIG. 28A show an example of the configuration of a piezoelectric vibrator in which the driving tines and the detection tine are extended in one direction with respect to the base, FIGS. 27B-D and FIGS. 28B-D are cross sectional views and perspective views of the driving tines and the detection tine, FIG. 27B and FIG. 28B are diagrams showing the driving mode, FIG. 27C and FIG. 28C are diagrams showing the detection mode, and FIG. 27D and FIG. 28D are diagrams showing the leakage vibration state.

The driving mode is a vibration mode in which the driving tines are driven in reverse phase (indicated by opposite-direction arrows in FIGS. 27B and 28B) in the plane formed by multiple driving tines (two driving tines are shown in FIGS. 27A and 28A). The Coriolis force, generated by the angular velocity, causes the driving tines to vibrate in the direction (out-of-plane direction) orthogonal to the plane described above. The detection mode is a mode in which both driving tines and detection tine vibrate in the out-of-plane direction and the driving tines vibrate in the out-of-plane direction in reverse phase. When an angular velocity is applied, the detection tine detects the vibration because the vibration of the driving tines generated by the Coriolis force and the detection mode resonate (FIG. 27C, 28C).

Note that the cross sectional shape of the driving tines is usually asymmetrical due to a formation error during the fabrication process. This asymmetry causes the driving tines to vibrate with an angle to the X-axis (FIG. 27D and FIG. 28D). The vibration caused by the asymmetry in the cross sectional shape of the driving tines, which is in reverse phase, causes a detection error when no angular velocity is applied and increases the vibration of the driving tines in the detection mode.

In view of the foregoing, it is an object of the present invention to solve the conventional problems, to make a piezoelectric vibrator compact, and to reduce leakage vibrations.

It is another object of the present invention to make it possible to suppress leakage vibrations without having to trim the mass of the vibration tines and thereby reduce the process time and the process cost.

### Means to Solve the Problems

At the frequency of the natural vibrations with which the driving tines and detection tine of a piezoelectric vibrator resonate, the present invention sets the vibration directions of natural vibrations and the frequency difference between the resonance frequencies to reduce the leakage of vibrations from the driving tines to the detection tine for suppressing the leakage vibration of the piezoelectric vibrator. In the piezoelectric vibrator, the vibration direction of the driving tines is made orthogonal to the vibration direction of the detection tine, or the frequency difference between the resonance frequency of the driving mode and the resonance frequency of the mode, in which the driving tines vibrate in reverse phase in the out-of-plane direction, is increased sufficiently to reduce the leakage vibration from the driving tines to the detection tine for suppressing the leakage vibration.

The inventor of the present invention has confirmed that, for the frequency difference between the resonance frequency of the driving mode and the resonance frequency, at which the driving tines vibrate in the out-of-plane direction, and the leakage amount, there is a relation that their product remains constant when they change. Based on this relation, when there is a leakage vibration from the driving tines to the detection tine, the present invention reduces the leakage of the vibration from the driving tines to the detection tine by increasing the frequency difference between the resonance frequency of the driving mode and the resonance frequency of the mode in which the driving tines vibrate in reverse phase in the out-of-plane direction.

The vibration directions and the resonance frequencies at the natural vibrations of the vibration tines (driving tines and detection tine) may be predetermined when a piezoelectric vibrator is designed. Therefore, there is no need for processes such as the trimming of the vibration tines for suppressing leakage vibrations.

A deviation in the resonance frequency of a vibration tine from the setting value, if caused, occurs only as a change in the amplitude of the vibration tine but does not affect the leakage vibration in which an unwanted vibration leaks from the driving tines to the detection tine.

There are multiple embodiments of a piezoelectric vibrator of the present invention in which, at the frequency of natural vibrations of the driving tines and the detection tine of the piezoelectric vibrator, the vibration directions and the resonance frequency differences of natural vibrations may be set.

Each of embodiments of a piezoelectric vibrator of the present invention comprises at least two driving tines; and at least one detection tine provided in a plane formed by the two driving tines. The driving tines and the detection tine have a base on which fixed ends thereof are fixed in common, and the detection tine is provided in such a way that the detection tine does not protrude beyond the base in a direction opposite to an extension direction in which the driving tines are extended from the base.

The positional relation between the detection tine and the base is that the end position of the base is assumed as a boundary in the side opposite to the extension direction side in which the driving tines extend from the base and, with this boundary as the boundary of the driving tine side, the tip of the detection tine does not protrude into the side opposite to the driving tines. By setting the positional relation between the detection tine and the base as described above, the driving tines and the detection tine are arranged in the same side of the boundary that is the end position of the base and are not extended into the opposite side beyond the boundary. Because of this configuration, the length of the piezoelectric vibrator is the sum of the length of the driving tine or the detection tine, whichever is longer, and the length of the base in the extension direction, and so, when compared with a piezoelectric vibrator with the conventional configuration in which the driving tines and the detection tine are extended in both sides of the base, the piezoelectric vibrator of the present invention is shorter.

A piezoelectric vibrator in a first embodiment of the present invention comprises the driving tines and the detection tine in the configuration described above wherein the resonance frequency (fa) of a vibration mode, in which the driving tines vibrate in reverse phase in a direction orthogonal to the in-plane direction, and the resonance frequency (fb) of a vibration mode, in which the driving tines vibrate in the in-plane direction, are separated in the frequency band, whereby the vibration transmission of a leakage vibration from the driving tines to the detection tine is reduced.

In the first embodiment, the natural vibrations, at which the driving tines and the detection tine vibrate in the direction orthogonal to the in-plane direction formed by the driving tines (out-of-plane direction), are set such that the resonance frequency (fa) of the driving tines and the resonance frequency (fb) of the driving tines are separated in the frequency band. As a result, when the driving tines vibrate in the vibration mode at the resonance frequency (fa), the leakage mount of vibrations to the detection tine is reduced for suppressing the effect of leakage vibrations.

A piezoelectric vibrator in a second embodiment of the present invention comprises the driving tines and the detection tine such as those in the first embodiment wherein the absolute value of a frequency difference (|fb−fc|) between the first resonance frequency (fb) of a vibration mode, in which the driving tines vibrate in reverse phase an in-plane direction, and the resonance frequency (fc) of a vibration mode, in which the detection tine vibrates in a direction orthogonal to the in-plane direction, is smaller than the absolute value of a frequency difference (|fb−fa|) between the first resonance frequency (fb) of the driving tines and the second resonance frequency (fa) of the driving tines of a vibration mode in which the driving tines vibrate in a direction orthogonal to the in-plane direction.

In the second embodiment, relatively increasing the frequency difference |fb−fa| prevents the forced vibration, generated by the Coriolis force of the driving tines, from inducing a vibration, called a beat tine vibration mode, in which the driving tines vibrate in reverse phase in a direction orthogonal to the in-plane direction (out-of-plane direction), and relatively decreasing the frequency difference |fb−fc| causes the detection tine to resonate with the forced vibration of the driving tines for detecting the angular velocity.

A piezoelectric vibrator in a third embodiment of the present invention comprises the driving tines and the detection tine such as those in the first embodiment wherein the resonance frequency (fa) of the vibration mode, in which the driving tines vibrate in reserve phase in a direction orthogonal to in-plane direction with almost the same amplitude, is made different greatly from the resonance frequency (fc) of the vibration mode, in which the detection tine vibrates in a direction orthogonal to the in-plane direction, and the resonance frequency (fB) of the vibration mode, in which the driving tines vibrate in the same phase in a direction orthogonal to an in-plane direction, and the resonance frequency (fc) of a vibration mode, in which the detection tine vibrates in a direction orthogonal to the in-plane direction, are set almost the same in frequency.

In the third embodiment, the resonance frequency (fa) of the vibration mode, in which the driving tines vibrate in a direction orthogonal to the in-plane direction, is made different greatly from the resonance frequency (fc) of the vibration mode of the detection tine. This prevents the vibration, called a beat tine vibration mode in which the driving tines vibrate in reverse phase in the out-of-plane direction, from affecting the detection tine. On the other hand, the resonance frequency (fB) of the vibration mode, in which the driving tines vibrate in the same phase in the out-of-plane direction, and the resonance frequency (fc) of the vibration mode, in which the detection tine vibrates in the out-of-plane direction, are set almost the same. As a result, even if the cross section shape of the driving tines is asymmetric, the out-of-plane vibrations generated in the driving tines are in reverse phase and the mode of the resonance frequency fB is the mode in which the driving tines vibrate in the same phase in the out-of-plane direction, meaning that the vibration methods are in opposite directions. This suppresses an increase in the out-of-plane vibration and suppresses the leakage vibration.

In a piezoelectric vibrator in a fourth embodiment of the present invention, the base comprises a fixed part, on which the driving tines and the detection tines are fixed, and a coupling part which couples the fixed part to a support part and is extended into an extension direction of the driving tines. This coupling part allows the driving tines and the detection tine, fixed on the fixed part, to be twistable with respect to the support part.

In the fourth embodiment, the driving tines vibrate in reverse phase in the plane formed by multiple driving tines in the driving mode. When the Coriolis force is generated by an angular velocity in the detection mode, the driving tines receive the Coriolis force in reverse phase in the out-of-plane direction orthogonal to the in-plane direction and are oscillated by the twisting operation of the coupling part. However, the driving tines, which move with the fixed part in one united body, do not vibrate flexurally with respect to the fixed part and do not vibrate in the out-of-plane direction orthogonal to the in-plane direction. On the other hand, when the coupling part is twisted, the detection tines vibrate in the out-of-plane direction. The resonance frequency (fD) of a vibration mode, in which the driving tines vibrate when the coupling part is twisted, is set almost the same as the resonance frequency (fc) of a vibration mode in which the detection tines vibrate in a direction orthogonal to the in-plane direction. The width of the amplitude in the out-of-plane direction depends on the twistability of the coupling part and the twistability of the coupling part depends, in turn, on the length of the tine of the coupling part. Therefore, increasing the length of the tine of the coupling part gives a large amplitude width, thus increasing the detection sensitivity.

The configuration, in which the tine of the coupling part is extended in the same direction as the extension direction of the driving tines, suppresses an increase in the length of the piezoelectric vibrator that might otherwise depend on the length of the coupling part.

The piezoelectric vibrator of the present invention has the following forms to provide configurations where the natural frequencies of the driving tines and the detection tines have the frequency relations described above in the first embodiment to the fourth embodiment.

In a first form, the width of the detection tine is made thinner than the width of the driving tine, and the shape of the cross section orthogonal to the longitudinal direction of the driving tines and the detection tine is made rectangular. The rectangular cross section shape of the driving tine allows the natural frequency of the driving tine in the in-plane direction to be separated in frequency from the natural frequency in the out-of-plane direction, resulting in a reduction in leakage vibrations.

In a second form, the driving tines are a rectangle whose thickness direction is longer, or whose width direction is longer, in the cross section shape thereof.

In a third form, when the driving tines are a rectangle whose thickness direction is longer in the cross section shape, the detection tine is made longer than the driving tines. Making the detection tine longer than the driving tines lowers the natural frequency of the detection tine and sets the natural frequency of the detection tine closer to the natural frequency of the driving tines in the in-plane direction.

In a fourth form, a weight is added to the tip of the detection tine. Adding a weight to the tip of the detection tine lowers the natural frequency of the detection tine, separates in frequency the natural frequency of the detection tine and the natural frequency of the driving tines in the out-of-plane direction and, at the same time, sets the natural frequency of the detection tine closer to the natural frequency of the driving tines in the in-plane direction.

In a fifth form, when the driving tine is a rectangle whose width direction is longer in the cross section shape, a weight is added to the tip of the driving tine. Adding a weight to the tip of the driving tine lowers the natural frequency. When a weight is added, the natural frequency of the driving tine is lowered, and the natural frequency of the detection tine is set close to the natural frequency of the driving tine in the in-plane direction.

In a sixth form, the driving tines have a groove in the longitudinal direction thereof and, in a seventh form, the cross section shape of the groove is almost H-shaped. The configuration in which the driving tines have a groove in the longitudinal direction makes the driving tines more rigid, lowers the natural frequency of the driving tines in the out-of-plane direction, and relatively increases the natural frequency of the driving tines in the in-plane direction, thus allowing the natural frequency of the driving tines in the out-of-plane direction and the natural frequency of the driving tines in the in-plane direction to be separated in frequency. In addition, making the cross section shape of the groove almost H-shaped makes the driving tines more rigid, increasing the effect described above.

In an eighth form, the tine of the coupling part is twisted by the Coriolis force generated by an angular velocity. This means that the tine of the coupling part may be used as the detection tine and that providing detection means on this tine generates the detection signal for detecting the angular velocity.

In addition, with the use of the piezoelectric vibrator described above, the present invention may be used to configure a vibration gyro in which the driving tines of the piezoelectric vibrator are driven at a predetermined frequency and the vibration, generated in the detection tine, is detected for measuring an external forced. The vibration gyro of the present invention, which has the features of the piezoelectric vibrator of the present invention described above, is compact and suppresses leakage vibrations. And, because the piezoelectric vibrator does not require process operations such as the trimming process operation, the cost is reduced and, in addition, the cost of the vibration gyro that uses the piezoelectric vibrator is reduced.

### EFFECTS OF THE INVENTION

The present invention makes a piezoelectric vibrator compact and reduces leakage vibrations.

The present invention suppresses leakage vibrations without having to trim the mass of the vibration tines. By doing so, the process time and the process cost of the trimming process, which are required for suppressing leakage vibrations, can be reduced.

### BRIEF DESCRIPTION OF THE DRAWINGS

FIG. 1 is a diagram showing one configuration example of a piezoelectric vibrator of the present invention and the outline of vibration modes selected when this piezoelectric vibrator is used as a vibration gyro.

FIG. 2 is a diagram showing the natural vibration mode of the driving tines of the piezoelectric vibrator of the present invention.

FIG. 3 is a diagram showing the natural vibration mode of the driving tines of the piezoelectric vibrator of the present invention.

FIG. 4 is a diagram showing the natural vibration mode of the driving tines of the piezoelectric vibrator of the present invention.

FIG. 5 is a diagram showing the natural vibration mode of the detection tines of the piezoelectric vibrator of the present invention.

FIG. 6 is a diagram showing the natural vibration mode of the detection tines of the piezoelectric vibrator of the present invention.

FIG. 7 is a diagram showing the induction of the detection mode from the driving mode in the piezoelectric vibrator of the present invention.

FIG. 8 is a diagram showing the induction of the detection mode from the driving mode in the piezoelectric vibrator of the present invention.

FIG. 9 is a diagram showing the induction of the detection mode from the driving mode in the piezoelectric vibrator of the present invention.

FIG. 10 is a diagram showing the relation between a detuning degree and leakage vibrations.

FIG. 11 is a diagram showing the relation between the natural frequencies fa and fb of the driving tine and the natural frequency fc of the detection tine.

FIG. 12 is a diagram showing the vibration status of the driving tines and the detection tine in embodiments for explaining first to third embodiments of the piezoelectric vibrator of the present invention.

FIG. 13 is a diagram showing the frequency relation in embodiments for explaining the first to third embodiments of the piezoelectric vibrator of the present invention.

FIG. 14 is a diagram showing the suppression of leakage vibrations generated by the asymmetric cross section shape of the driving tines of the piezoelectric vibrator of the present invention.

FIG. 15 is a diagram showing first to fourth arrangement configuration examples of the driving tines and the detection tines with respect to the base of the piezoelectric vibrator of the present invention.

FIG. 16 is a diagram showing fifth to seventh arrangement configuration examples of the driving tines and the detection tines with respect to the base of the piezoelectric vibrator of the present invention.

FIG. 17 is a diagram showing eighth and ninth arrangement configuration examples of the driving tines and the detection tines with respect to the base of the piezoelectric vibrator of the present invention.

FIG. 18 is a diagram showing tenth to fifteenth arrangement configuration examples of the driving tines and the detection tines with respect to the base of the piezoelectric vibrator of the present invention.

FIG. 19 is a diagram showing a sixteenth configuration example of the piezoelectric vibrator of the present invention.

FIG. 20 is a cross section diagram showing the driving tine in a sixteenth configuration example of the present invention.

FIG. 21 is a top view showing a form example of a fourth embodiment of the present invention.

FIG. 22 is a diagram showing the operation status of the driving mode and the detection mode in one form example in the fourth embodiment of the present invention.

FIG. 23 is a diagram showing the operation status of the driving mode and the detection mode in one form example in the fourth embodiment of the present invention.

FIG. 24 is a diagram showing another configuration example of the piezoelectric vibrator of the present invention.

FIG. 25 is a diagram showing the circuit configuration example of the piezoelectric vibrator of the present invention.

FIG. 26 is a diagram showing the configuration of a conventional piezoelectric vibrator.

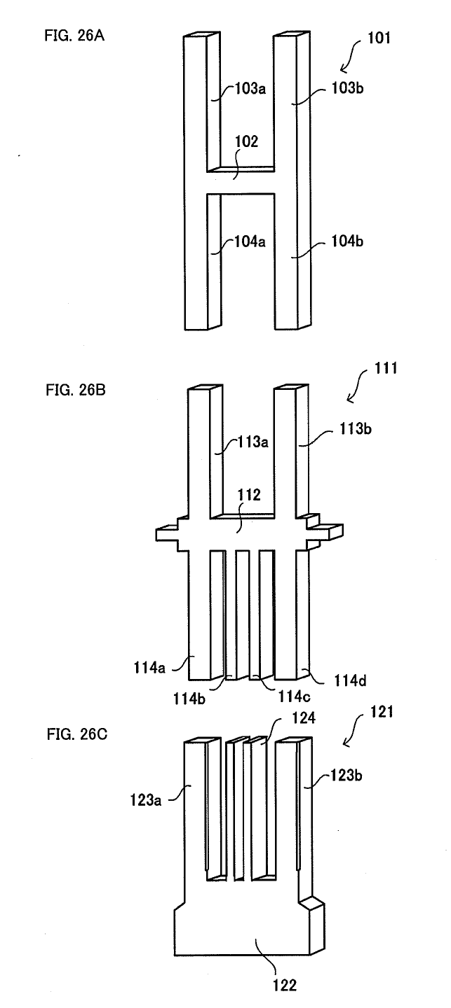

FIG. 27 is a diagram showing the driving mode, detection mode, and leakage vibrations of driving tines.

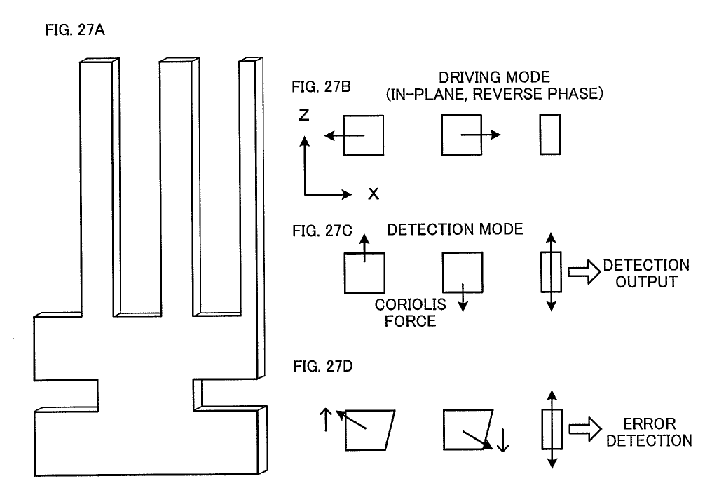

FIG. 28 is a diagram showing the driving mode, detection mode, and leakage vibrations of driving tines.

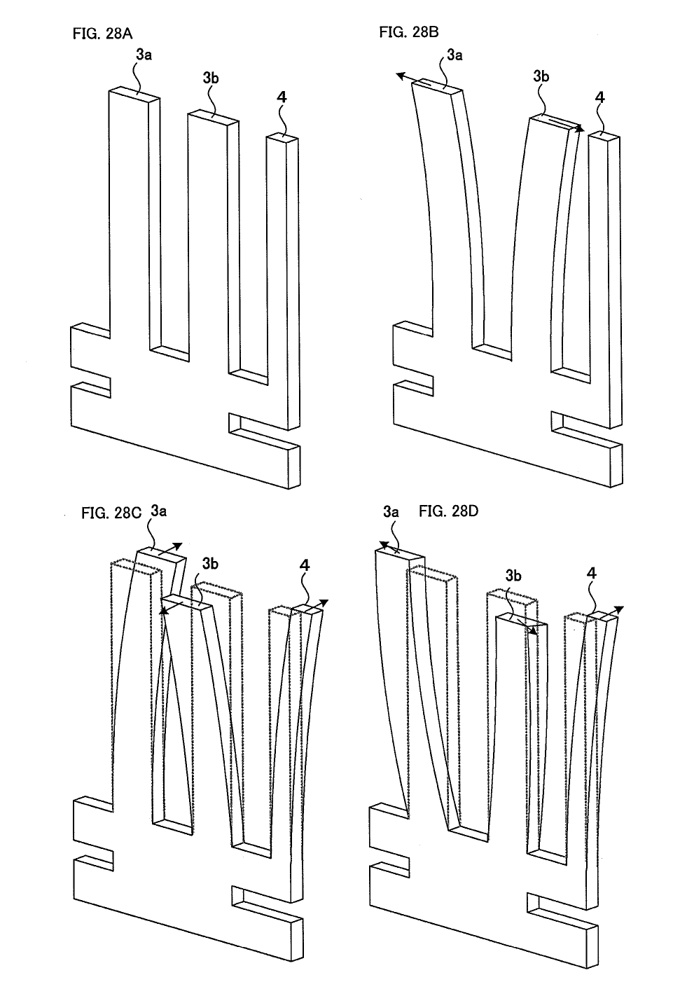

### DESCRIPTION OF SYMBOLS

1 Piezoelectric vibrator
2 Base
3, 3a, 3b, 3A, 3B Driving tine
4, 4a, 4b Detection tine
5 Fixed part
6 Support part
7 Coupling part
8 End
9 Boundary
10, 10a, 10b Groove
11a, 11b Driving electrode
11c Detection electrode
101 Piezoelectric vibrator
102 Base
103a, 103b Driving tine
104a, 104b Detection tine
111 Piezoelectric vibrator
112 Base
113a, 113b Driving tine
114a, 114b Detection tine
121 Piezoelectric vibrator
122 Base
123a, 123b Driving tine
124a, 124b Detection tine

### BEST MODE FOR CARRYING OUT THE INVENTION

The present invention will be described in detail below with reference to the drawings.

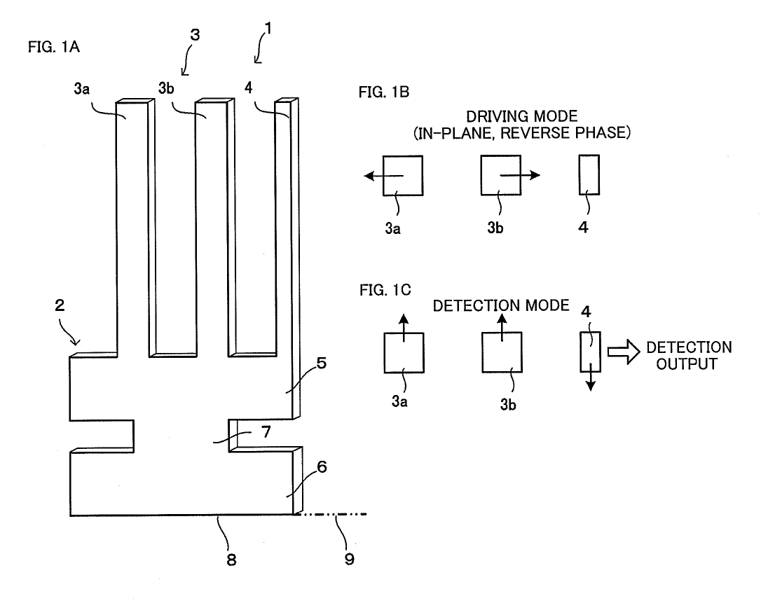

FIG. 1 is a diagram showing an example of the configuration of a piezoelectric vibrator of the present invention and the outline of the vibration mode that is selected when this piezoelectric vibrator is used as a vibration gyro.

FIG. 1A is a diagram showing an example of one configuration of a piezoelectric vibrator 1. Although the piezoelectric vibrator 1 shown in this figure is an example of the piezoelectric vibrator that comprises two driving tines 3(3a, 3b) and one detection tine 4 provided in the plane formed by the two driving tines, the number of driving tines is not limited to two but may be two or more and the number of detection tines is not limited to one but may be one or more.

The driving tines 3 and the detection tine 4 are configured in such away that they have their fixed ends fixed on a base 2 and that the driving tines 3 and the detection tine 4 are extended in the same direction with respect to the base 2, not protruded on the side of the base 2 opposite to the extension direction.

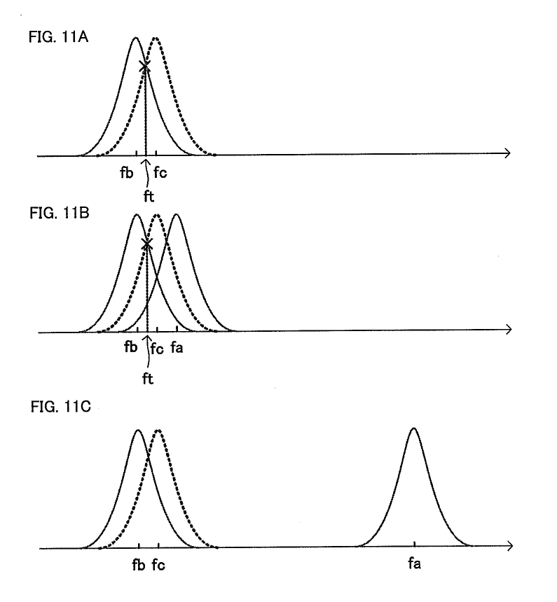

FIG. 1 shows the configuration of the base 2 in which a fixed part 5 and a support part 6 are coupled via a coupling part 7. The driving tines 3 and the detection tine 4 are fixed on the fixed part 5, and the support part 6 is used to install the piezoelectric vibrator, for example, on the casing of a vibration gyro. The driving tines 3 and the detection tine 4 are fixed on the fixed part 5 of the base 2, and the detection tine 4 is not extended on the opposite side of a tine that extends beyond a boundary 9 that is the extension from the position of an end 8 of the support part 6 of the base 2. Examples of the configuration of this detection tine will be described later with reference to FIG. 11-FIG. 16.

FIG. 1B to FIG. 1C are diagrams showing the cross sections of the tines in the plane formed by the driving tines 3(3a and 3b) and the detection tine 4. FIG. 1B shows the vibration state in the driving mode, and FIG. 1C shows the vibration state in the detection mode.

The driving mode and the detection mode are vibration modes selected when the piezoelectric vibrator 1 is used as a vibration gyro.

The driving mode is the vibration state in which vibration is generated by supplying the driving current to the electrodes provided on the driving tines. The vibration frequency of the vibration tines at this time is determined by the natural vibration frequency of the driving tines, and the amplitude is determined by the supplied power and the Q value.

The detection mode is the vibration mode induced when the Coriolis force is generated by the external force of the angular velocity ω when the piezoelectric vibrator 1 is in the driving mode and, as a result, the out-of-plane vibration is generated on the driving tines. The Coriolis force, when generated, starts the forced vibration in the detection mode, meaning that the vibration frequency of the detection tine is determined by the vibration frequency of the driving tines and that the amplitude is determined by the detuning degree between the vibration frequency of the driving tines and the natural frequency of the detection tine.

FIG. 1B shows the driving mode started when the driving tines 3a and 3b are driven in reverse phase in the plane formed by those driving tines. In the figure, the state in which the driving tines 3a and 3b are vibrated in the opposite directions (arrows in the figure) indicates one driving direction when the driving tines are driven in reverse phase.

The driving mode described above is set by the supply state of the driving current applied to the electrodes on the driving tines of the piezoelectric vibrator 1.

FIG. 1C shows the detection mode in which the detection tine starts vibration when the external force of the angular velocity ω is applied to the driving tines 3a and 3b in the driving mode.

The Coriolis force, generated by applying the external force of the angular velocity ω, generates a vibration component that causes the driving tines 3a and 3b to vibrate in the direction (out-of-plane direction) orthogonal to the plane formed by the driving tines 3a and 3b. The arrows in the figurer show the vibration component in the out-of-plane direction.

Because coupled to the driving tines 3a and 3b via the base 2, the detection tine 4 vibrates in the out-of-plane direction when subject to the forced vibration in the out-of-plane direction generated in the driving tines 3a and 3b. The detection electrode on the detection tine 4 detects this vibration.

Each of the driving tines and the detection tine of the piezoelectric vibrator 1 has a natural vibration mode determined by the shape of the tine and the tine fixing state and, by vibrating the tine at the natural frequency of the natural vibration mode, the tine vibrates in the predetermined vibration mode. Note that, in this natural vibration mode, the tine vibrates also at a non-natural frequency but the resonance frequency based on the natural frequency results in large amplitude.

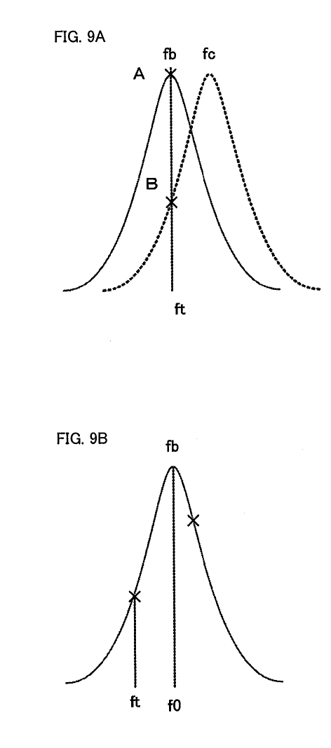

FIG. 9B is a diagram showing the vibration state of a tine. In FIG. 9B, the characteristic curve schematically shows the relation between the driving frequency and the amplitude of the tine at natural frequency f0. When the tine is forced to be vibrated at frequency ft, the tine is vibrated at the frequency ft corresponding to the forced vibration and the amplitude at that time is determined by the characteristic curve. The amplitude is largest when the frequency ft of the forced vibration is the natural frequency f0 of the tine.

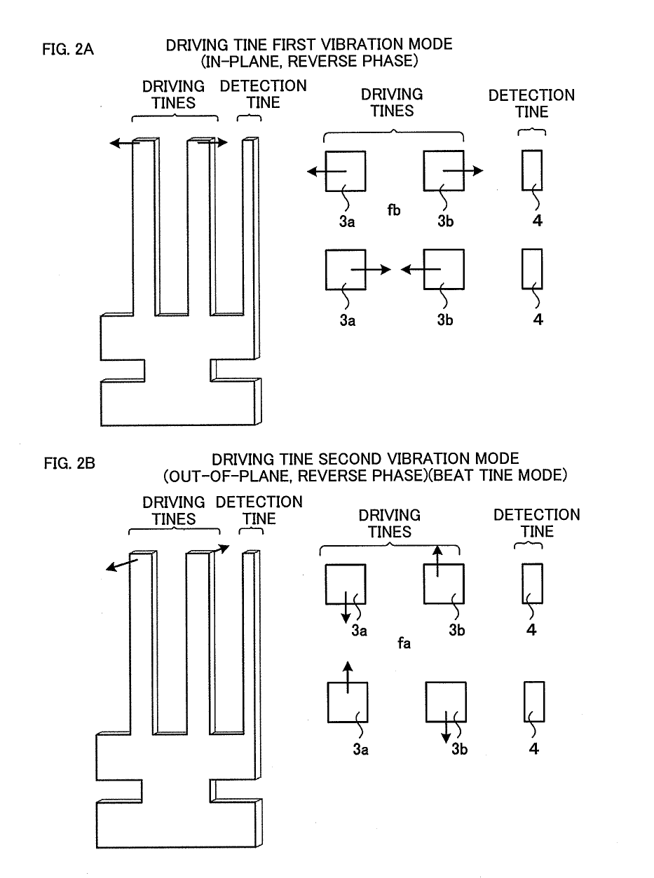

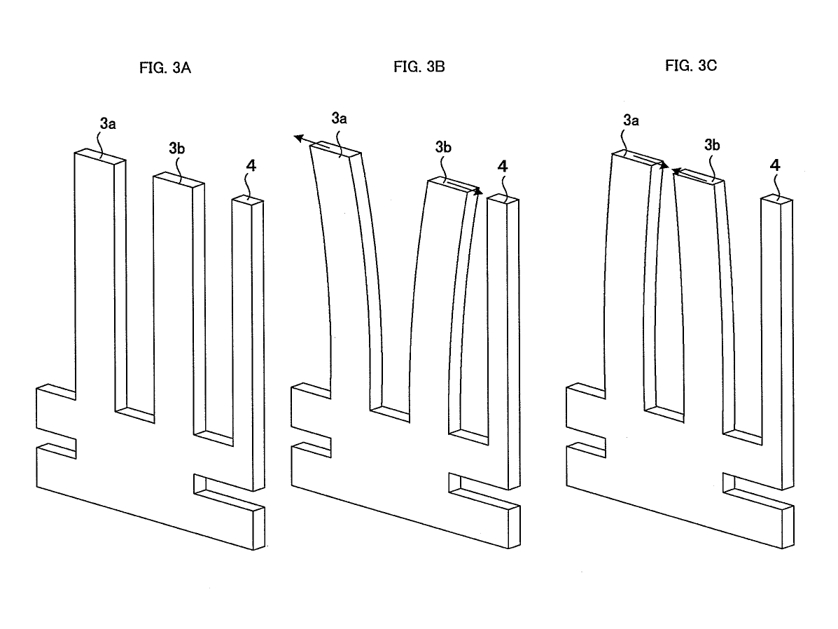

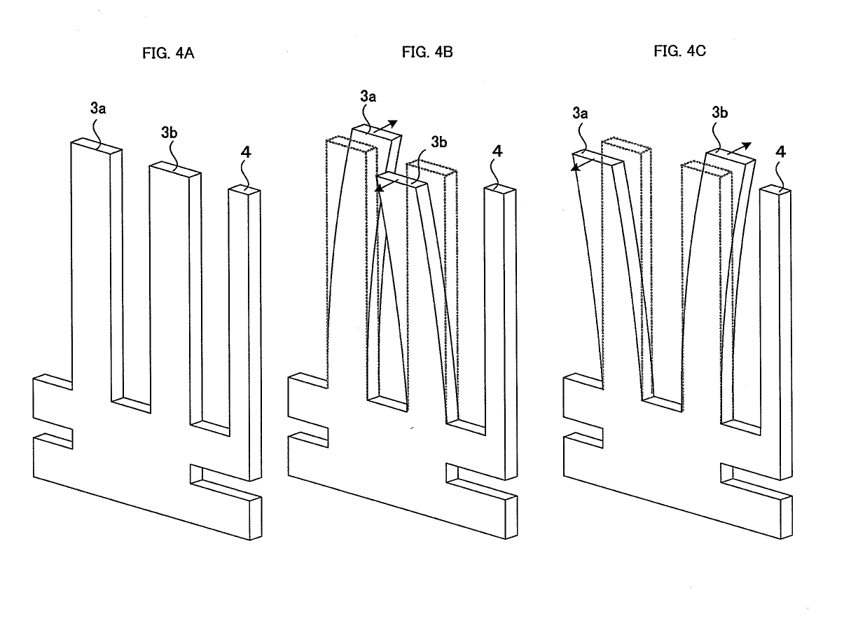

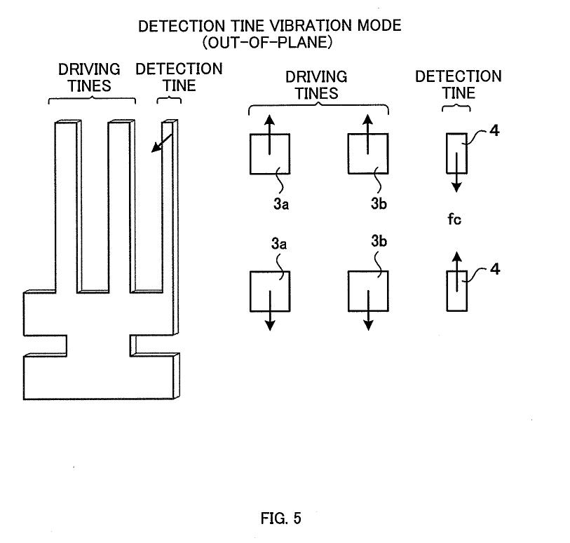

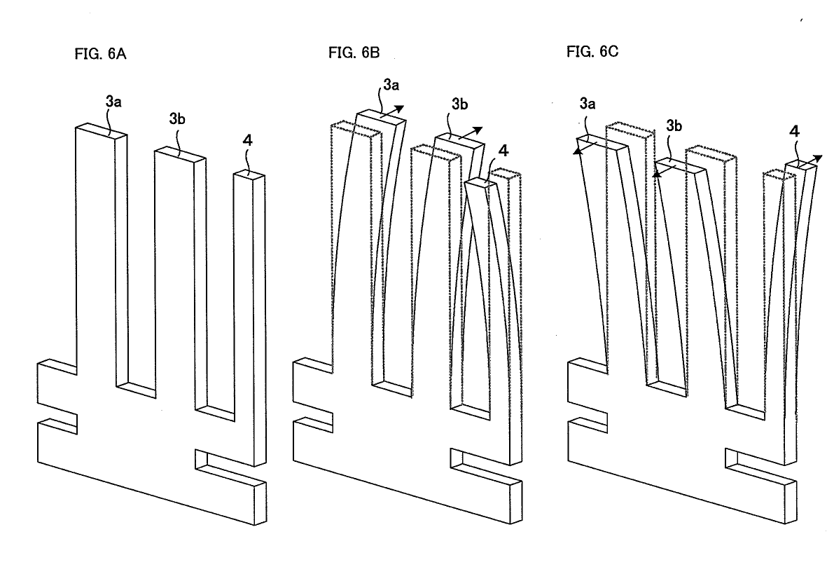

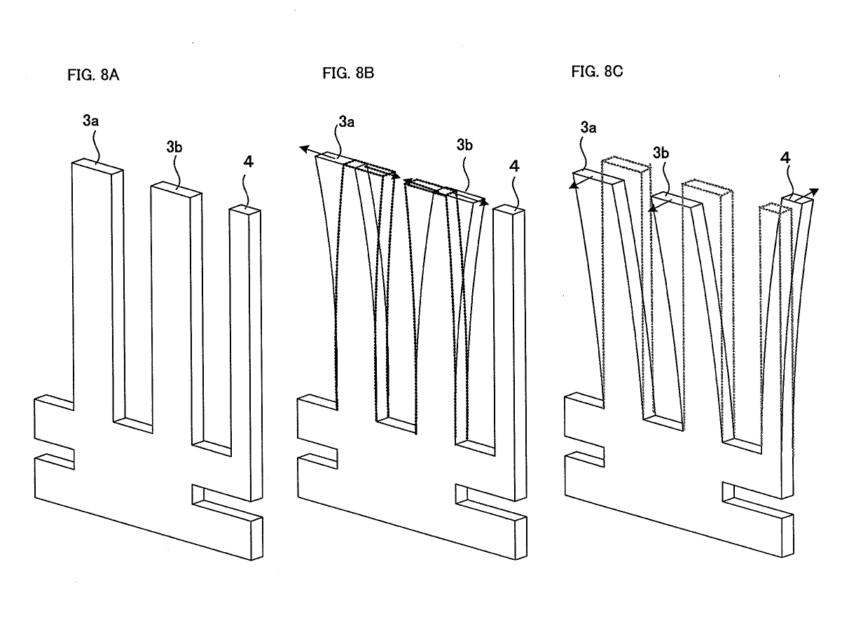

The following describes the natural vibration mode of a piezoelectric vibrator with reference to FIG. 2 to FIG. 6. FIG. 2 to FIG. 4 show the resonance vibration mode of the driving tines, and FIG. 5 and FIG. 6 show the resonance vibration mode of the detection tine. FIG. 3A, FIG. 4A, FIG. 5A, FIG. 6A, and FIG. 8A show a piezoelectric vibrator in the still state.

FIG. 2 to FIG. 4 show the two types of the resonance vibration mode of the driving tines.

FIG. 2A and FIG. 3 show the first vibration mode of the driving tines and, in this vibration mode, the driving tines vibrate in reverse phase in the plane formed by the driving tines. The arrows in the figure show the vibration direction of the driving tines 3a and 3b in one vibration state. The driving tines 3a and 3b repeatedly vibrate in the opposite directions to each other. FIGS. 3B and 3C show the vibration state in which the driving tines 3a and 3b vibrate in the opposite directions each other in the in-plane direction. The resonance frequency at this time is determined by the shape of the driving tines and the fixing state of the driving tines.

FIG. 2B and FIG. 4 show the second vibration mode of the driving tines and, in this vibration mode, the driving tines vibrate in reverse phase in the direction orthogonal to the plane formed by the driving tines (out-of-plane direction). The arrows in the figure show the vibration direction of the driving tines 3a and 3b in one vibration state and, as shown in the figure, the driving tines 3a and 3b vibrate in the opposite directions to each other in the out-of-plane directions. FIGS. 4B and 4C show the vibration state in which the driving tines 3a and 3b vibrate in the opposite directions to each other in the out-of-plane direction. This vibration mode in reverse phase in the out-of-plane direction is called a beating mode.

On the other hand, FIG. 5 and FIG. 6 show the natural vibration mode of the detection tine.

The detection tine 4 vibrates in the direction orthogonal to the plane formed by the driving tines 3a and 3b (out-of-plane direction). The arrow in the figure shows the vibration direction. FIG. 6B and FIG. 6C show the vibration state in which the driving tines 3a and 3b vibrate in the same direction in the out-of-plane direction and the detection tine 4 vibrates in the direction opposite to the vibration direction of the driving tines 3a and 3b. The resonance frequency at this time is determined by the shape of the detection tine and the fixing state of the detection tine.

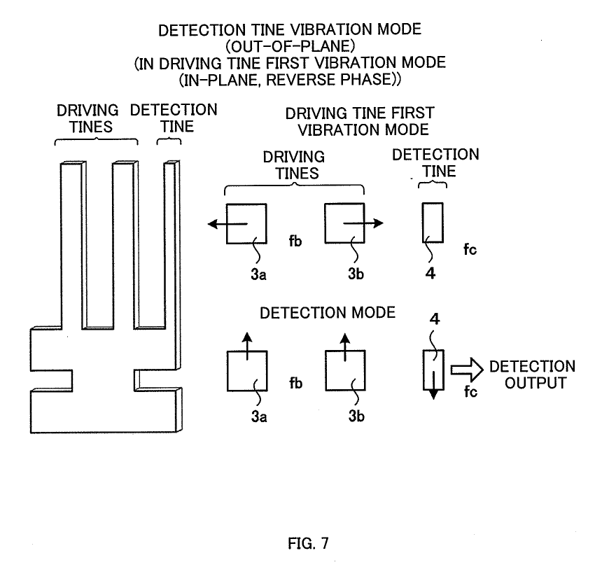

Next, with reference to FIG. 7 to FIG. 9, the following describes how the detection mode is induced from the driving mode in the piezoelectric vibrator of the present invention. FIG. 7 shows the vibration state using the cross sectional positions of the driving tines and the detection tine, and FIG. 8 is a perspective view showing the vibration state of the driving tines and the detection tine.

In the description below, the first vibration mode of the driving tines is called the driving mode and the vibration mode of the detection tine is called the detection mode. The detection mode is induced from the driving mode. The detection mode of the piezoelectric vibrator is induced from the driving mode when the driving current is supplied to the driving electrode of the piezoelectric vibrator to drive the driving tines at a predetermined frequency for starting the driving mode and, in this driving mode, the Coriolis force is generated by an external force such as the angular velocity ω. The vibration frequency at this time is not the resonance frequency in the detection mode but the vibration frequency in the driving mode.

FIGS. 7 and 8 show that the driving mode is started by driving the driving tines in the first vibration mode shown in FIG. 2A and that the detection mode is induced from this driving mode. In the first vibration mode, the driving tines are vibrated in reverse phase in the plane (FIG. 8B). In the figure, fb indicates the resonance frequency of the driving tines, fc indicates the resonance frequency of the detection tine, and the driving tines are vibrated at the frequency ft. In the case of self-excited oscillation, ft is almost equal to fb.

Because the driving tines vibrate in reverse phase in the in-plane direction, the driving tines receive the Coriolis force in reverse phase in the out-of-plane direction when the angular velocity is applied in this vibration state in reverse phase. However, in the vicinity of the driving vibration frequency, there is no mode in which the driving tines vibrate in reverse phase in the out-of-plane direction but there is only the vibration mode in which the driving tines vibrate in the same phase in the out-of-plane direction or the vibration mode that does not involve a vibration in the out-of-plane direction. Therefore, the vibration in the vibration mode in the vicinity of the driving vibration frequency is induced in practice. This induced vibration is the vibration mode in which the driving tines vibrate in the same phase in the out-of-plane direction or the vibration mode that does not involve a vibration in the out-of-plane direction.

For example, when the angular velocity ω is applied in the state in which the driving tines are vibrated at the frequency ft to start the driving mode, the driving tines 3a and 3b vibrate in the same phase in the out-of-plane direction at the frequency ft. The detection tine 4 resonates in reverse phase to the driving tines in the out-of-plane direction at the frequency ft to compensate for the vibration of the driving tines 3a and 3b in the out-of-plane direction (FIG. 8C).

FIG. 9A and FIG. 9B show the relation of the frequencies at this time.

The driving tines have the characteristic curve (indicated by the solid line) that has the amplitude peak at the resonance frequency fb, and the detection tine has the characteristic curve (indicated by the broken line) having the amplitude peak at the resonance frequency fc. When the resonance frequency fb of the driving tines is close to the resonance frequency fc of the detection tine, the characteristic curve of the driving tines partially overlaps with that of the detection tine.

When forced to be driven by the Coriolis force, the driving tines vibrate at the frequency ft. In FIG. 9A, the magnitude of the amplitude of the driving tines is indicated by point A. In this case, when the frequency ft is set equal to the resonance frequency fb of the driving tines, the amplitude of the driving tines is the largest amplitude on the characteristic curve. On the other hand, the detection tine resonates with the vibration of the driving tines and vibrates at the same frequency ft. The amplitude at this time is indicated by point B on the characteristic curve of the detection tine.

The resonance frequency of the driving tines and the detection tine is the frequency the amplitude of which is the largest in its vicinity. The driving tines and the detection tine vibrate even when the frequency is shifted from the resonance frequency with the amplitude decreasing in proportion to the amount of shift from the resonance frequency.

The amplitude W, which is proportional to the inverse number of the difference between the frequency ft of the forced vibration and the resonance frequency fs, may be represented by the following expression.

W=k/|ft−fs| (1)

where k is the proportionality constant that is proportional to the amplitude of the forced vibration.

The expression (1) given above indicates that the smaller the frequency difference |ft−fs| between the frequency ft of the forced vibration and the resonance frequency fs is, the larger the amplitude W is and the higher detection efficiency is. When the frequency difference |ft−fs| gets near “0”, the operation becomes unstable. Therefore, when fc is the resonance frequency of the detection tine used in the detection mode and fb is the resonance frequency of the driving tines used in the driving mode, the frequency difference |fb−fc| is set, for example, to several hundred Hz or lower.

As described above, the driving tines are driven in the driving mode in the in-plane direction of the plane formed by the driving tines, the driving tines are vibrated in the out-of-plane direction by the forced vibration through the Coriolis force generated by the application of the angular velocity ω, and the vibration is detected by causing the detection tine to resonate with the out-of-plane vibration of the driving tines. In addition to the natural mode in which the driving tines vibrate in the in-plane direction as shown in FIG. 2A and FIG. 3, the driving tines have a natural mode in which the driving tines vibrate in the out-of-plane direction as they do in the second vibration mode, called a beat tine mode, shown in FIG. 2B and FIG. 4.

When the vibration mode in which the driving tines vibrate in the in-plane direction is used as the driving mode, the leakage vibration from the driving tines to the detection tine is suppressed because the driving tines vibrate in the in-plane direction whereas the detection tine vibrates in the out-of-plane direction.

For example, when fc is the resonance frequency of the detection tine and fb is the resonance frequency of the driving tines used in the driving mode, the relation shown in expression (1) given above indicates that the amplitude in the detection mode corresponding to the leakage vibration is increased when the frequency difference |fb−fc| is small.

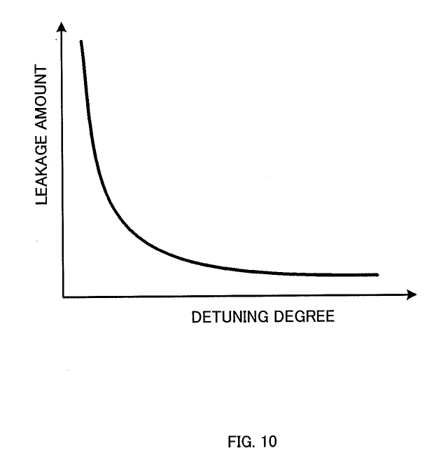

FIG. 10 is a diagram showing the relation between the detuning degree and the leakage vibration and, as shown in this figure, the leakage vibration is proportional to the inverse number of the detuning degree. The detuning degree is a value corresponding to the frequency difference, and the smaller the detuning degree is, the larger the leakage vibration is.

To solve this problem, the present invention separates the resonance frequency fa in the natural mode, at which the driving tines vibrate in the out-of-plane direction in the second vibration mode called a beat tine mode shown in FIG. 2B and FIG. 4, apart from the resonance frequency f(b) of the driving tines used in the driving mode, based on the relation between the detuning degree and the leakage vibration. By doing so, the leakage vibration from the driving tines to the detection tine is reduced.

FIG. 11 is a diagram showing the relation between the resonance frequencies fa and fb of the driving tines and the resonance frequency fc of the detection tine. In FIG. 11A, it is assumed that the driving tines 3a and 3b have the resonance frequency fa in the out-of-plane direction and the resonance frequency fb in the in-plane direction and that the detection tine 4 has the resonance frequency fc in the out-of-plane direction.

FIG. 11A is a diagram showing the frequency relation in the driving mode state. When the driving tines are driven in the in-plane direction at the frequency ft in the driving mode, the driving tines vibrate in the in-plane direction with the amplitude determined by the frequency ft on the characteristic curve (natural frequency fb) of the driving tines. On the other hand, the detection tine, which has the natural vibration in the out-of-plane direction, does not resonate with the driving tines. When the Coriolis force is applied and the driving tines vibrate in the out-of-plane direction, the detection tine resonates with the driving tines and outputs the detection signal.

FIG. 11B shows that the resonance frequency fb of the driving tines in the in-plane direction, the resonance frequency fa of the driving tines in the out-of-plane direction, and the resonance frequency fc of the detection tine in the out-of-plane direction are close with each other. When vibrated in the in-plane direction at the frequency ft at this time, the driving tines vibrate in the in-plane direction with the amplitude determined by the frequency ft on the characteristic curve (resonance frequency fb). If the driving tines are ideally formed and there is no size error, the driving tines vibrate completely in the in-plane direction and there is no vibration at the resonance frequency fa that is the frequency of the out-of-plane vibration; actually, however, a size error introduced during the fabrication causes the driving tines to vibrate slightly in the out-of-plane direction. At this time, if this out-of-plane vibration is close to the vibration at the resonance frequency fa in the out-of-plane vibration mode as in this case, the vibration of the driving tines resonates with this vibration and, as a result, the out-of-plane vibration is increased. In addition, because the resonance frequency fc of the detection tine is close to the frequency of this out-of-plane vibration, this out-of-plane vibration resonates with the detection tine and, as a result, the detection tine is vibrated greatly. This vibration results in a leakage vibration.

On the other hand, when the resonance frequency fa of the driving tines in the out-of-plane direction is separated apart from the resonance frequency fc of the detection tine (FIG. 11C), the out-of-plane vibration of the driving tines, generated due to a size error during the fabrication, is not increased and its amplitude is small. Therefore, there is little or no leakage vibration even when the frequency ft is close to the resonance frequency fc of the out-of-plane vibration of the detection tine. This relation corresponds to a reduction in the amplitude W by increasing the vibration difference |ft−fa| that is the denominator of expression (1) given above.

Therefore, it can be said that the leakage vibration is reduced conventionally by trimming the driving tines to decrease the amplitude (corresponds to the constant k in expression (1)) of the forced vibration that is the source of the vibration in expression (1) while the leakage vibration is reduced in the present invention by increasing the frequency difference |ft−fa| that is the denominator of expression (1).

In addition, even when the size error is so large that the out-of-plane vibration of the driving tines becomes somewhat large, the present invention prevents the out-of-plane vibration from being increased, thus suppressing the amplitude of the leakage vibration.

This frequency difference, which is determined in such a way that the resonance frequency fa of the driving tines in the out-of-plane direction is separated apart from the resonance frequency fb of the driving tines in the in-plane direction, can be accomplished by appropriately setting the shape and the length of the driving tines or by properly adjusting fixing the driving tines. Because high formation accuracy is not required for setting the shape and the length of the driving tines, the tines can be formed by a simple fabrication process and no trimming is necessary.

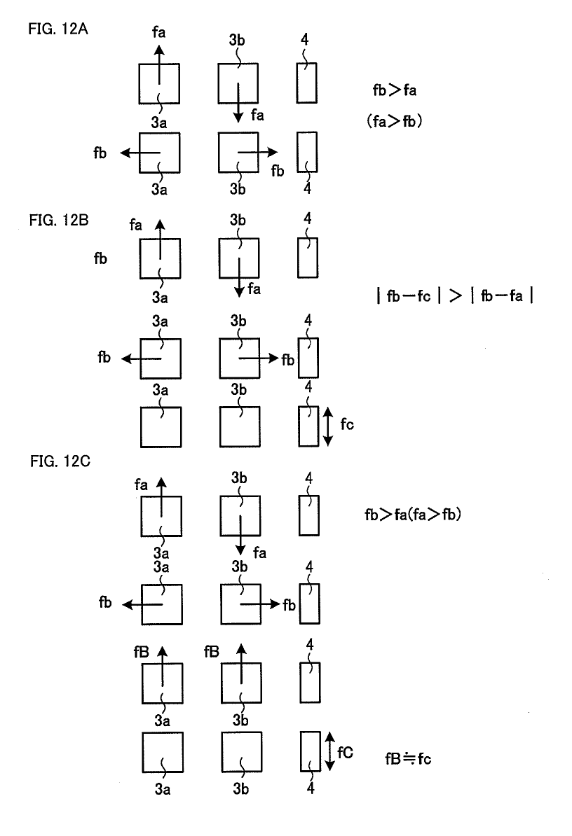

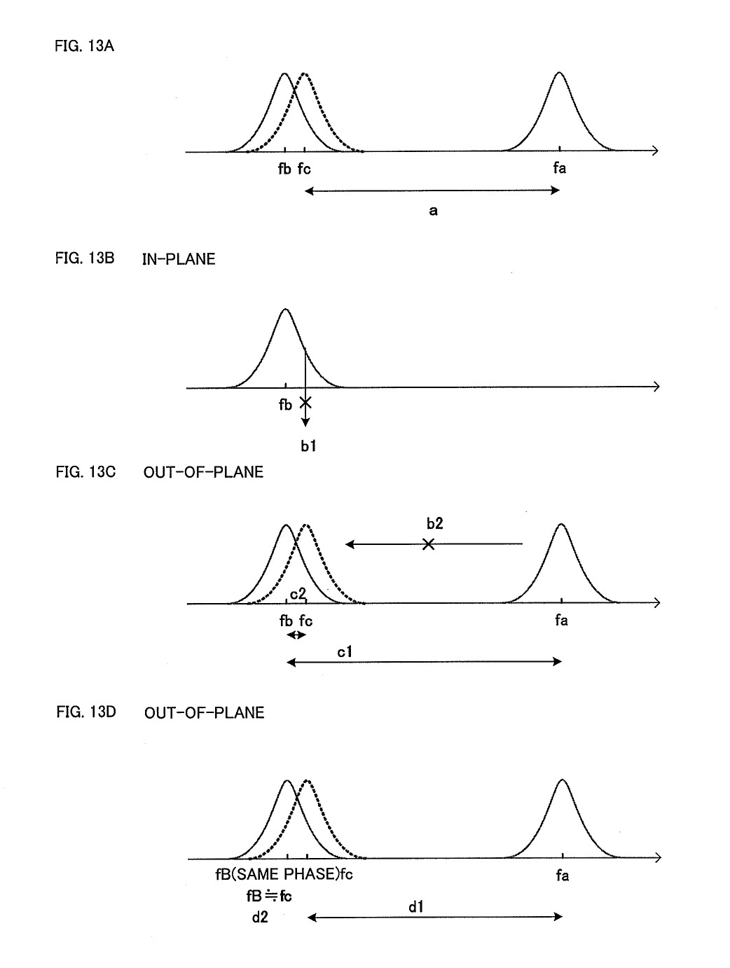

Next, the following describes a first embodiment to a third embodiment of a piezoelectric vibrator of the present invention with reference to FIG. 12 and FIG. 13. FIG. 12 is a diagram showing the vibration state of the driving tines and the detection tine in the embodiments, and FIG. 13 is a diagram showing the frequency relation in the embodiments.

In the first embodiment of the piezoelectric vibrator of the present invention, the resonance frequency (fa) in the vibration mode in which the driving tines 3a and 3b vibrate in reverse phase in the direction orthogonal to the in-plane direction (out-of-plane direction) and the resonance frequency (fb) in the vibration mode in which the driving tines 3a and 3b vibrate in reverse phase in the in-plane direction are separated apart in the frequency band (FIG. 12A, a in FIG. 13A).

In the first embodiment, the resonance frequency (fa) at which the driving tines 3a and 3b vibrate in the direction orthogonal to the in-plane direction (out-of-plane direction) and the resonance frequency (fb) at which the driving tines vibrate in the in-plane direction are separated distant apart in the frequency band. Setting the frequencies in this way prevents the vibration of the driving tines in the out-of-plane direction from being increased when the driving tines vibrate near the resonance frequency (fb) and, as a result, reduces the leakage amount to the detection tine.

In the piezoelectric vibrator of the present invention, the vibration mode of the driving tines 3a and 3b and the vibration mode of the detection tine 4 have orthogonality that does not affect with each other the vibration transmission between the driving tines and the detection tine in the vibration states at the resonance frequencies fa, fb, and fc (FIG. 12A, FIG. 13B, and FIG. 13C).

Referring to FIG. 13B and FIG. 13C, the vibration of the driving tines in the in-plane direction does not affect the vibration of the detection tine in the out-of-plane direction because of the orthogonality (b1 in FIG. 13B). Actually, however, a size error introduced during the fabrication generates a slight vibration in the out-of-plane direction. However, in the piezoelectric vibrator of the present invention, the resonance frequency fb of the driving tines in the in-plane direction and the resonance frequency fa of the driving tines in the out-of-plane direction are separated distant apart in the frequency band and, so, the out-of-plane vibration is not increased with no effect on the detection tine. In the vibration mode of the driving tines at the frequency fa shown in FIG. 13C, the driving tines vibrate in reverse phase each other in the direction orthogonal to the in-plane direction (out-of-plane direction). This mode is also called a beat vibration mode.

In the piezoelectric vibrator in the second embodiment of the present invention, the frequency relation is as follows. That is, the absolute value of the frequency difference (|fb−fc|) between the first resonance frequency fb of the vibration mode, in which the driving tines 3a and 3b vibrate in reverse phase in the in-plane direction, and the resonance frequency fc (detection mode) of the vibration mode in which the detection tine 4 vibrates in the direction orthogonal to the in-plane direction is smaller than the absolute value of the frequency difference (|fb−fa|) between the first resonance frequency fb of the driving tines 3a and 3b and the second resonance frequency fa of the driving tines in the vibration mode in which the driving tines 3a and 3b vibrate in the direction orthogonal to the in-plane direction (FIG. 12A, FIG. 13C).

In this embodiment, the frequency difference (|fb−fa|) is made relatively larger (c1 in FIG. 13C) to suppress the resonance of the out-of-plane vibration, generated by a fabrication error of the driving tines, with the beat vibration mode. When the driving tines are forced to vibrate through the Coriolis force, its amplitude is made sufficiently larger than that of the out-of-plane vibration, generated by a fabrication error, and the frequency difference |fb−fc| is made relatively smaller (c2 in FIG. 13C) to allow the forced vibration to resonate with the detection mode to vibrate the detection tine for detecting the angular velocity.

In the piezoelectric vibrator in the third embodiment of the present invention, the frequency relation is as follows. That is, the resonance frequency fa of the vibration mode in which the driving tines 3a and 3b vibrate in reverse phase in the out-of-plane direction with almost the same amplitude is made different greatly from the resonance frequency fb of the vibration mode in which the driving tines vibrate in the in-plane direction (FIG. 12C, d1 in FIG. 13D) and the resonance frequency fB of the vibration mode in which the driving tines vibrate in the same phase in the out-of-plane direction is set almost equal to the resonance frequency fc of the vibration mode in which the detection tine vibrates in the out-of-plane direction (FIG. 12C and d2 in FIG. 13D).

In this embodiment, the resonance frequency fa of the out-of-plane vibration mode of the driving tines is made different greatly from the resonance frequency fb of the in-plane vibration mode of the driving tines (d1 in 13D) to prevent an out-of-plane vibration due to a fabrication error of the driving tines from resonating with the vibration, called a beat vibration mode, in which the driving tines vibrate in reverse phase each other in the out-of-plane direction. In addition, the resonance frequency fB of the vibration mode in which the driving tines vibrate in the same phase in the out-of-plane direction is set almost equal to the resonance frequency fc of the vibration mode in which the detection tine vibrates in the out-of-plane direction (d2 in FIG. 13D) to prevent the out-of-plane vibration due to a fabrication size error from being increased.

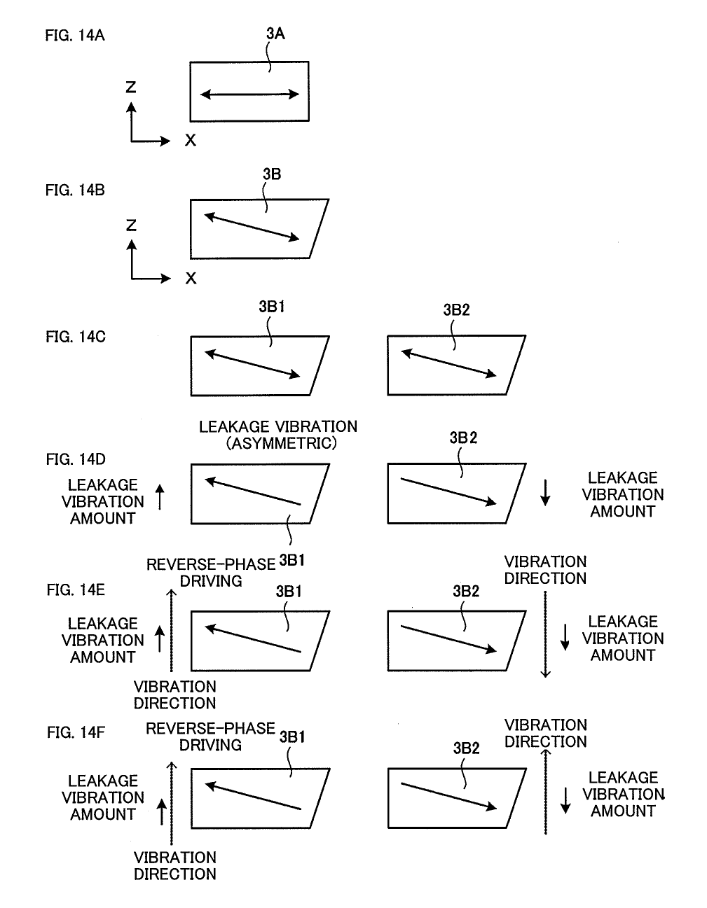

The piezoelectric vibrator of the present invention uses the vibration mode, in which the driving tines vibrate in the same phase in the out-of-plane direction, as the detection to suppress the leakage vibration generated by the asymmetric cross section shape of the driving tines. The following describes the suppression of leakage vibrations with reference to FIG. 14. In FIG. 14, the direction of driving vibration is the X-axis and the direction orthogonal to the X-axis is the Z-axis.

FIG. 14A shows the case in which the driving tine 3A has a shape symmetric with respect to the X-axis. When the shape of the driving tine 3A is symmetric with respect to the X-axis, the driving vibration is parallel to the X-axis when the driving axis 3A is vibrated in the X-axis direction.

On the other hand, FIG. 14B shows the case in which the driving tine 3B has a shape asymmetric with respect to the X-axis. In this case, the cross section shape of the driving tine is sometimes, not symmetric, but asymmetric due to a fabrication error.

When the shape of the driving tine 3B is asymmetric with respect to the X-axis, the tine bends easily in one direction but not so easily in another with the result that the cross-section main axis is inclined. Therefore, when the driving tine 3B is vibrated in the X-axis direction, the driving vibration is not parallel to the X-axis but a vibration component in the Z-axis direction is generated and, as a result, the vibration direction of the driving vibration has an angle to the X-axis. This vibration component in the Z-axis direction is a leakage vibration (FIG. 14B).

The multiple driving tines of the piezoelectric vibrator are formed in the similar process, meaning that their cross section shapes have the similar shape characteristics. In FIG. 14, a deformed rectangle represents an asymmetric shape.

In general, because the vibration of the two driving tines is generated as a tuning fork vibration, both tines are driven in reverse phase and they move away and then come close each other. When the two driving tines, which are asymmetric in the same direction, vibrate in reverse phase, the leakage vibrations that vibrate in the out-of-plane direction are also in reverse phase (FIG. 14D).

In this case, if the detection mode is the mode in which the driving tines vibrate in reverse phase, the leakage vibrations generated by the asymmetric cross section shape are also in reverse phase. This means that the vibration direction and the leakage vibration direction are in the same direction and so the amplitude of the out-of-plane vibration is increased (FIG. 14E).

On the other hand, if the detection mode is the mode in which the driving tines vibrate in the same phase in the out-of-plane direction, the leakage vibrations generated doe to the asymmetric cross section shape are in reverse phase in the out-of-plane direction. This means that one of the driving tines increases the vibration in the out-of-plane direction but the other driving tine suppresses the vibration in the out-of-plane direction, resulting in suppressed amplitude of the out-of-plane vibration and a reduced leakage vibration (FIG. 14F).

Therefore, the use of the vibration mode, in which the driving tines vibrate in the same phase in the in-plane direction, as the detection mode enhances the suppression effect of the leakage vibration.

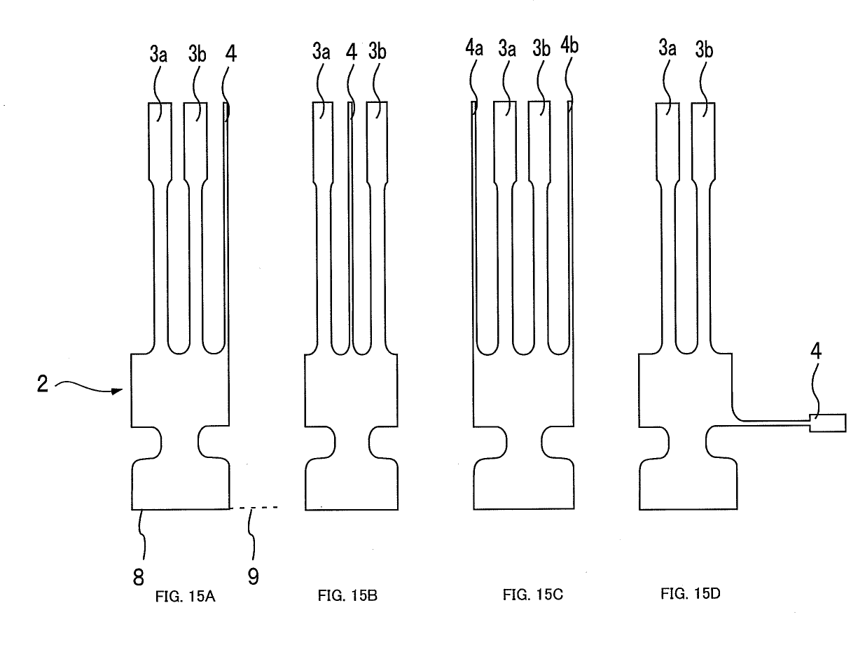

Next, referring to FIG. 15 to FIG. 18, the following describes examples of the arrangement configuration of the driving tines and the detection tine with respect to the base 2 of the piezoelectric vibrator of the present invention.

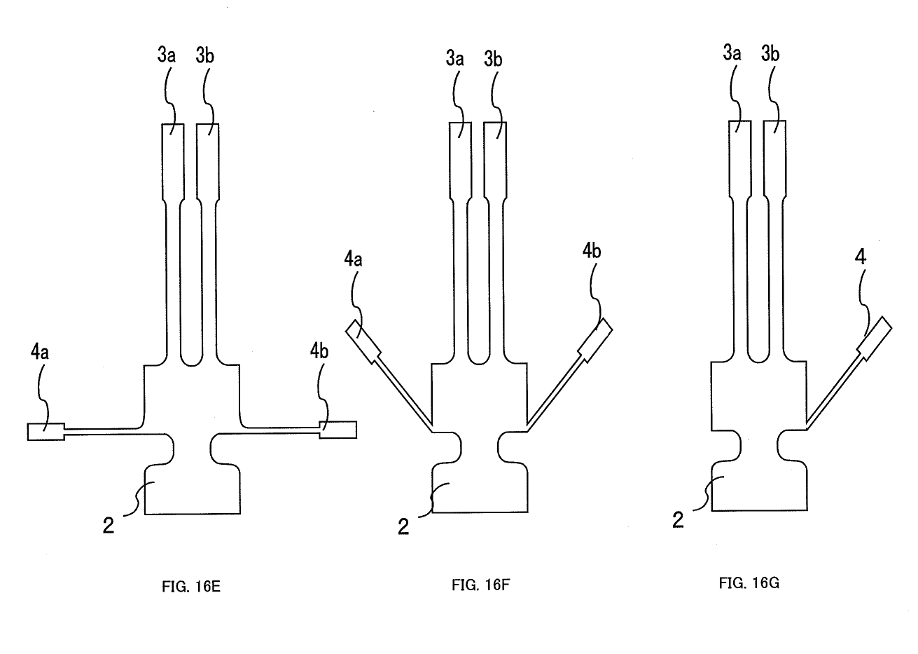

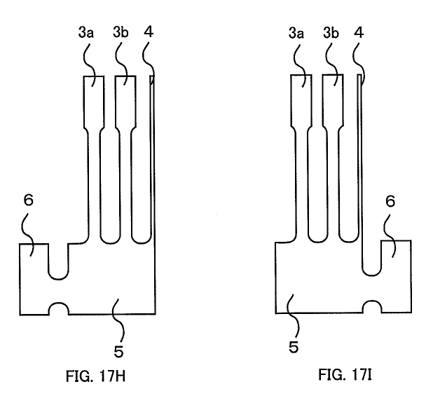

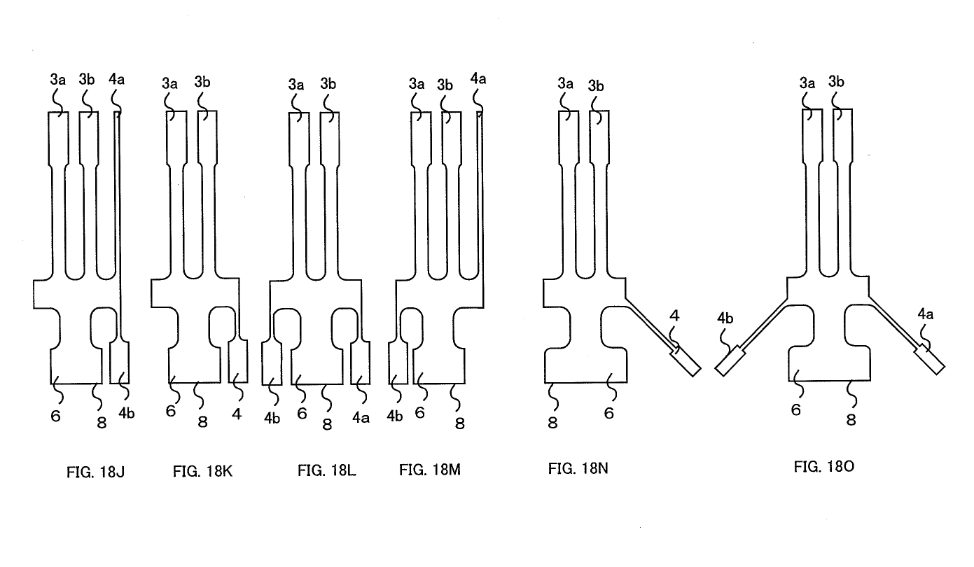

FIG. 15A to FIG. 15D are diagrams showing first to fourth configuration examples, FIG. 16E to FIG. 16G are diagrams showing fifth to seventh configuration examples, FIG. 17H and FIG. 17I are diagrams showing eighth and ninth configuration examples, and FIG. 18J to FIG. 18O are diagrams showing tenth to fifteenth configuration examples.

In the first configuration example (FIG. 15A) and the second configuration example (FIG. 15B), the piezoelectric vibrator has two driving tines 3a and 3b and one detection tine 4 that are extended from the base 2 in parallel in the extension direction. The detection tine 4 is extended from the end of the base 2 in the first configuration example, and the detection tine 4 is provided between the two driving tines 3a and 3b in the second configuration example. The driving tines 3a and 3b have their tips swelled to form a weight, and the detection tine 4 is formed thin.

In the third configuration example (FIG. 15C)), the piezoelectric vibrator has two driving tines 3a and 3b and two detection tines 4a and 4b that are extended from the base 2 in parallel in the extension direction. In this configuration, the detection tines 4a and 4b are extended each from one of the ends of the base 2 and the two driving tines 3a and 3b are provided between the detection tines 4a and 4b. The driving tines 3a and 3b have their tips swelled to form a weight, and the detection tines 4 are formed thin.

In the fourth configuration example (FIG. 15D), the piezoelectric vibrator has two driving tines 3a and 3b and one detection tine 4. The two driving tines 3a and 3b are extended from the base 2 in parallel in the extension direction while the detection tine 4 is extended from the base 2 in the direction orthogonal to the extension direction of the driving tines 3a and 3b. The driving tines 3a and 3b and the detection tine have their tips swelled to form a weight. The detection tine 4 has its tip swelled to form a weight to reduce the length of the detection tine 4 in the extension direction.

In the fifth configuration example (FIG. 16E) and the sixth configuration example (FIG. 16F), the piezoelectric vibrator has two driving tines 3a and 3b and two detection tines 4a and 4b. The two driving tines 3a and 3b are extended from the base 2 in parallel in the extension direction while the detection tines 4a and 4b are extended from the base 2 in directions different from the extension direction of the driving tines 3a and 3b. In the fifth configuration example, the detection tines 4a and 4b are extended in the direction orthogonal to the extension direction of the driving tines 3a and 3b, 180 degrees opposite each other and, in the sixth configuration example, the detection tines 4a and 4b are extended into the extension directions, which are symmetric with each other, at an acute angle with the extension direction of the driving tines 3a and 3b. The driving tines 3a and 3b and the detection tines 4a and 4b have their tips swelled to form a weight. The detection tines 4a and 4b have their tips swelled to form a weight to reduce the length of the detection tines 4a and 4b in the extension direction.

In the seventh configuration example (FIG. 16G), the piezoelectric vibrator has two driving tines 3a and 3b and one detection tine 4. The two driving tines 3a and 3b are extended from the base 2 in parallel in the extension direction while the detection tine 4 is extended from the base 2 in a direction different from the extension direction of the driving tines 3a and 3b. The detection tine 4 is extended in a direction at an acute angle with the extension direction of the driving tines 3a and 3b. The driving tines 3a and 3b and the detection tine 4 have their tips swelled to form a weight. The detection tine 4 has its tip swelled to reduce the length of the detection tine in the extension direction.

In the eighth configuration example (FIG. 17H) and the ninth configuration example (FIG. 17I), the piezoelectric vibrator has two driving tines 3a and 3b and one detection tine 4. The two driving tines 3a and 3b are extended from the base 2 in parallel in the extension direction while the detection tine 4 is extended from the end of the base 2 in parallel with, and in the same direction as that of, the extension direction of the driving tines 3a and 3b. The support part 6, which forms the base 2, is provided on the fixed part 5 in the direction orthogonal to the extension direction of the driving tines 3a and 3b.

In the eighth configuration example, the support part 6 is provided on the side opposite to the side on which the detection tine 4 is provided while, in the ninth configuration example, the support part 6 is provided on the same side on which the detection tine 4 is provided. In those configurations, the driving tines 3a and 3b have their tips swelled to form a weight, and the detection tine 4 is formed thin.

In the tenth configuration example (FIG. 18J), the piezoelectric vibrator has two driving tines 3a and 3b and two detection tines 4a and 4b. The two driving tines 3a and 3b are extended from the base 2 in parallel in the extension direction while one of the detection tines, 4a, is extended from the base 2 in parallel with, and in the same direction as that of, the driving tines 3a and 3b and the other detection tine, 4b, is extended from the base 2 in the direction opposite to the extension direction of the driving tines 3a and 3b. The two detection tines 4a and 4b are extended from the fixed part 5 of the base 2 in 180 degrees opposite directions. The leading end position of the detection tine 4b should not exceed the extension of the end 8 of the support part 6 of the base 2. Fabricating the piezoelectric vibrator such that the leading end position of the detection tine 4b does not exceed the extension of the end 8 of the support part 6 of the base 2 reduces the size of the piezoelectric vibrator.

The driving tines 3a and 3b and the detection tine 4b have their tips swelled to form a weight, and the detection tine 4a is formed thin. The detection tine 4b has its tip swelled to form a weight to reduce the length of the detection tine 4 in the extension direction.

In the eleventh configuration example (FIG. 18K), the piezoelectric vibrator has two driving tines 3a and 3b and one detection tine 4. The two driving tines 3a and 3b are extended from the base 2 in parallel in the extension direction while the detection tine 4 is extended from the base 2 in the direction opposite to the extension direction of the driving tines 3a and 3b. The leading end position of the detection tine 4 should not exceed the extension of the end 8 of the support part 6 of the base 2. Fabricating the piezoelectric vibrator such that the leading end position of the detection tine 4 does not exceed the extension of the end 8 of the support part 6 of the base 2 reduces the size of the piezoelectric vibrator.

The driving tines 3a and 3b and the detection tine 4 have their tips swelled to form a weight. The detection tine 4 has its tip swelled to form a weight to reduce the length of the detection tine 4 in the extension direction.

In the twelfth configuration example (FIG. 18L), the piezoelectric vibrator has two driving tines 3a and 3b and two detection tines 4a and 4b. The two driving tines 3a and 3b are extended from the base 2 in parallel in the extension direction while the detection tines 4a and 4b are extended from the base 2 in the direction opposite to the extension direction of the driving tines 3a and 3b. The leading end position of the detection tines 4a and 4b should not exceed the extension of the end 8 of the support part 6 of the base 2. Fabricating the piezoelectric vibrator such that the leading end positions of the detection tines 4a and 4b do not exceed the extension of the end 8 of the support part 6 of the base 2 reduces the size of the piezoelectric vibrator.

The driving tines 3a and 3b and the detection tines 4a and 4b have their tips swelled to form a weight. The detection tines 4a and 4b have their tips swelled to form a weight to reduce the length of the detection tines 4a and 4b in the extension direction.

In the thirteenth configuration example (FIG. 18M), the piezoelectric vibrator has two driving tines 3a and 3b and two detection tines 4a and 4b. The two driving tines 3a and 3b are extended from the base 2 in parallel in the extension direction while one of the detection tines, 4a, is extended from the base 2 in parallel with, and in the same direction as that of, the driving tines 3a and 3b and the other detection tine, 4b, is extended from the base 2 in the direction opposite to the extension direction of the driving tines 3a and 3b. The two detection tines 4a and 4b are extended in 180 degrees opposite directions from the fixed part 5 of the base 2 and provided on both ends of the fixed part 5, one for each. The leading end position of the detection tine 4b should not exceed the extension of the end 8 of the support part 6 of the base 2. Fabricating the piezoelectric vibrator such that the leading end position of the detection tine 4b does not exceed the extension of the end 8 of the support part 6 of the base 2 reduces the size of the piezoelectric vibrator.

The driving tines 3a and 3b and the detection tine 4b have their tips swelled to form a weight, and the detection tine 4a is formed thin. The detection tine 4b has its tip swelled to form a weight to reduce the length of the detection tine 4 in the extension direction.

In the fourteenth configuration example (FIG. 18N), the piezoelectric vibrator has two driving tines 3a and 3b and one detection tine 4. The two driving tines 3a and 3b are extended from the base 2 in parallel in the extension direction while the detection tine 4 is extended from the base 2 in a direction different from the extension direction of the driving tines 3a and 3b. The detection tine 4 is extended in a direction at an obtuse angle with the extension direction of the driving tines 3a and 3b.

The leading end position of the detection tine 4 should not exceed the extension of the end 8 of the support part 6 of the base 2. Fabricating the piezoelectric vibrator such that the leading end position of the detection tine 4 does not exceed the extension of the end 8 of the support part 6 of the base 2 reduces the size of the piezoelectric vibrator. In addition, the detection tine 4 is extended from the base 2 obliquely. Compared with the configuration in which the detection tine 4 and the driving tines 3a and 3b are in the directions 180 degrees opposite each other, this configuration allows the tine to be prolonged and the detection tine to be designed more flexibly.

The driving tines 3a and 3b and the detection tine 4 have their tips swelled to form a weight. The detection tine 4 has its tip swelled to form a weight to reduce the length of the detection tine 4 in the extension direction.

In the fifteenth configuration example (FIG. 18O), the piezoelectric vibrator has two driving tines 3a and 3b and two detection tines 4a and 4b. The two driving tines 3a and 3b are extended from the base 2 in parallel in the extension direction while the detection tines 4a and 4b are extended from the base 2 in directions different from the extension direction of the driving tines 3a and 3b. The detection tines 4a and 4b are extended from the base 2 in opposite directions, each at an obtuse angle with the extension direction of the driving tines 3a and 3b.

The leading end positions of the detection tines 4a and 4b should not exceed the extension of the end 8 of the support part 6 of the base 2. Fabricating the piezoelectric vibrator such that the leading end position of the detection tine 4 does not exceed the extension of the end 8 of the support part 6 of the base 2 reduces the size of the piezoelectric vibrator. In addition, the detection tines 4a and 4b are extended from the base 2 obliquely. Compared with the configuration in which the detection tines 4a and 4b are extended in the directions 180 degrees opposite to the extension direction of the driving tines 3a and 3b, this configuration allows the tines to be prolonged and the detection tines to be designed more flexibly.

The driving tines 3a and 3b and the detection tines 4a and 4b have their tips swelled to form a weight. The detection tines 4a and 4b have their tips swelled to form a weight to reduce the length of the detection tines 4a and 4b in the extension direction.

In the configuration examples described above, the driving tines 3a and 3b have their tips swelled to form a weight to adjust the length of the tines and to reduce the size of the piezoelectric vibrator.

In the configuration examples described above, the width of the detection tine is thinner than the width of the driving tines, and the cross section shape of the plane orthogonal to the longitudinal direction of the driving tines and the detection tines is a rectangle. Making the width of the detection tine thinner than the width of the driving tines allows separation in frequency between the resonance frequency of the vibration of the detection tine in the in-plane direction and the resonance frequency of the driving tines in the in-plane direction. Making the cross section shape of the driving tines a rectangle allows separation in frequency between the natural frequency of the vibration of the driving tines in the in-plane direction and the natural frequency of the vibration of the driving tines in the out-of-plane direction.

The driving tines may be a rectangle whose thickness direction is longer, or whose width direction is longer, in the cross section shape.

When the cross section shape of the driving tines is a rectangle whose thickness direction is longer, the natural frequency of the vibration of the driving tines in the in-plane direction is lower than the natural frequency of the beat tine mode; when the cross section shape of the driving tines is a rectangle whose width direction is longer, the natural frequency of the vibration of the driving tines in the in-plane direction is higher than the natural frequency of the beat tine mode.

The thickness of the driving tines is the same as that of the detection tines and so, when the cross section shape of the driving tines is a rectangle whose thickness direction is longer, the resonance frequency of the vibration (driving mode) of the driving tines in the in-plane direction is lower than the resonance frequency of the vibration (detection mode) of the detection tines in the out-of-plane direction. Sufficiently high detection sensitivity requires that the resonance frequency of the driving mode be close to the resonance frequency of the detection mode. In this case, therefore, it is required that the detection tine be made longer to lower the natural frequency of the detection mode or that a weight be added to the tip of the detection tines to lower the natural frequency of the detection mode.

When the cross section shape of the driving tines is a rectangle whose width direction is longer, the resonance frequency of the vibration (driving mode) of the driving tines in the in-plane direction is higher than the resonance frequency of the vibration (detection mode) of the detection tines in the out-of-plane direction. Sufficiently high detection sensitivity requires that the resonance frequency of the driving mode be close to the resonance frequency of the detection mode. In this case, therefore, it is required that the driving tines be made longer to lower the resonance frequency of the driving mode or that a weight be added to the tip of the driving tines to lower the resonance frequency of the driving mode.

As means for separating, in frequency, between the resonance frequency of the vibration of the driving tines in the in-plane direction and the resonance frequency of the vibration of the driving tines in the out-of-plane direction, a groove is cut in a part of each of the driving tines.

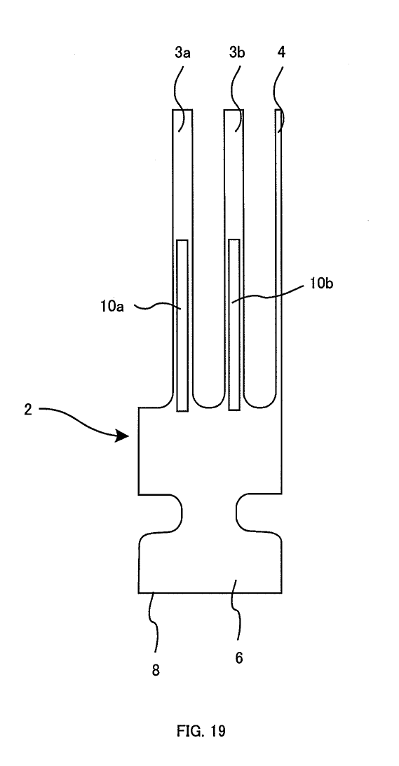

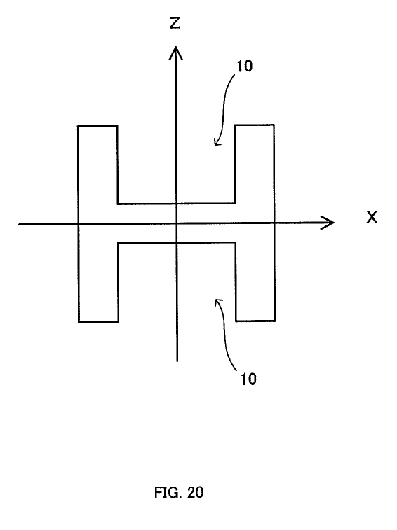

The following describes a sixteenth configuration example with reference to FIG. 19 and FIG. 20. In the sixteenth configuration example, a groove is cut in apart of each driving tine. As shown in FIG. 19, grooves 10a and 10b are formed on the driving tines 3a and 3b and, as shown in the cross section diagram in FIG. 20, a groove 10 is formed with the cross section of the driving tines 3a and 3b approximately as an H-shaped tine. A driving tine with this groove 10 thereon makes the second moment of area about the X-axis smaller than the second moment of area about the Z-axis. This allows the natural frequency of the vibration (driving mode) of the driving tines in the in-plane direction (X-axis direction) sufficiently higher than the natural frequency of the vibration (beat tine mode) of the driving tines in the out-of-plane direction (Z-axis direction), thus making it possible to separate between the driving mode and the beat tine mode in frequency.

In this case, the resonance vibration frequency of the driving tines may be separated in frequency between that in the in-plane direction and that in the out-of-plane direction by the effect of the grooves and, in addition, the driving tines may be fabricated such that the thickness and the width are equal. Therefore, even if the driving tines and the detection tine are almost of the same length, the resonance frequency of the driving tines in the in-plane direction may be set close to the resonance frequency of the detection tine. This means that a configuration is possible in which the driving tines and the detection tine are almost of the same length and no weight is added as shown in FIG. 19. In this case, too, any of the first to fifteenth configurations may be used.

The fourth embodiment of the piezoelectric vibrator of the present invention is characterized in the configuration of the coupling part that is a part of the base and is coupled with the support part. This coupling part is extended in the same direction as the extension direction of the driving tines with its end coupled with the support part in such a way that the coupling part is twistable with respect to the support part.

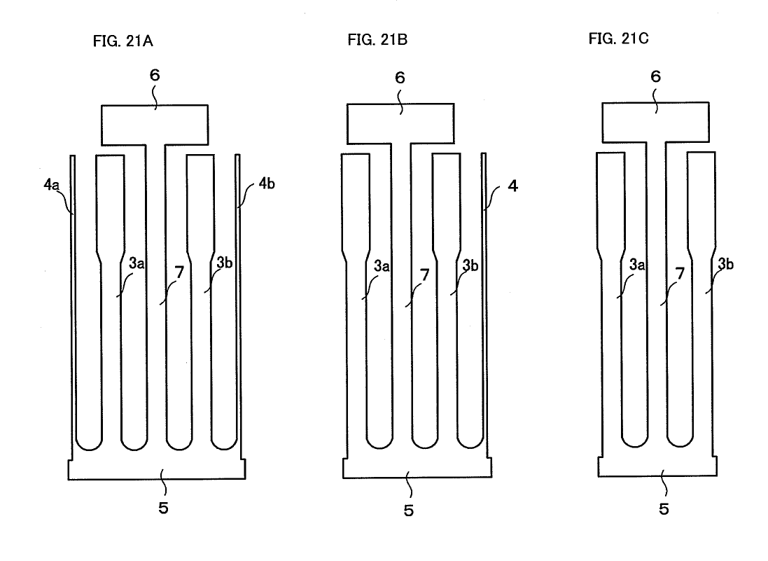

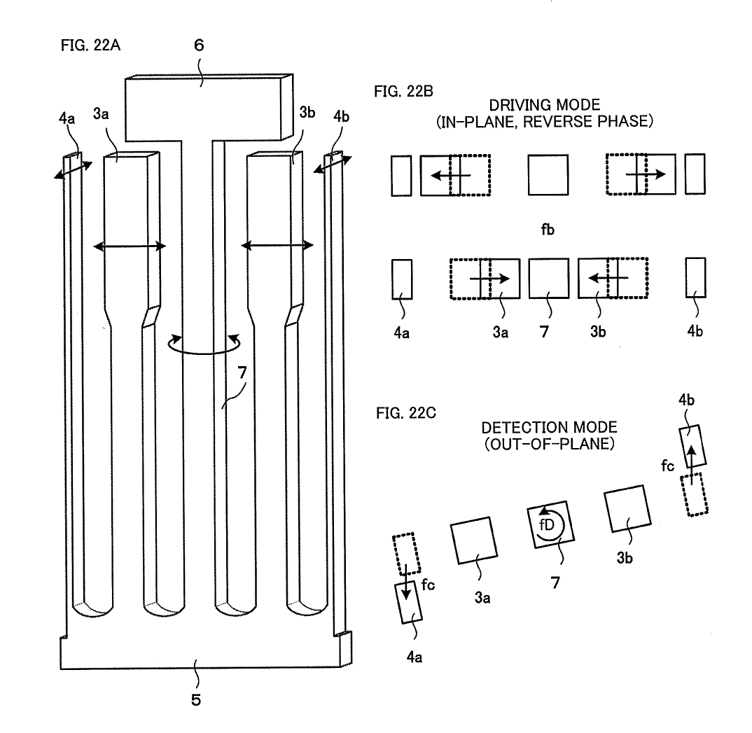

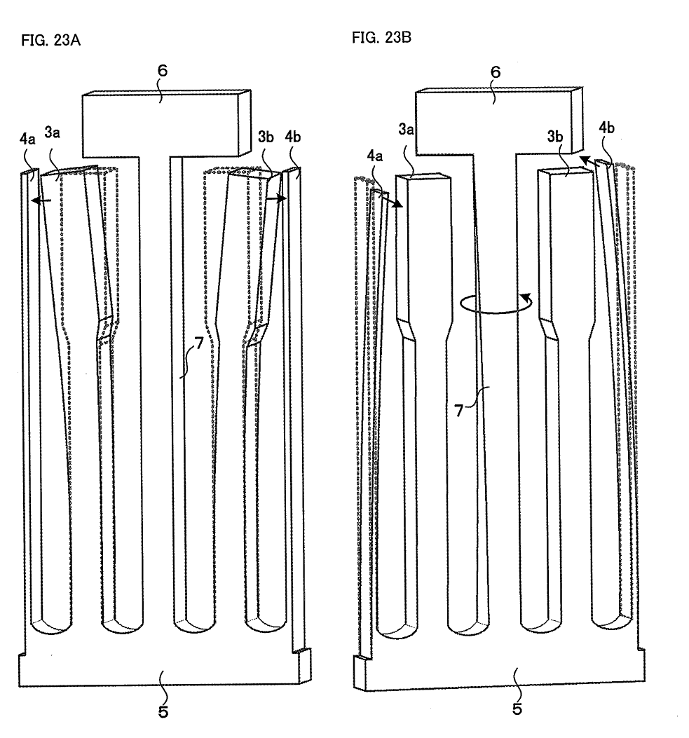

FIG. 21 is a top view showing an example of the form of the fourth embodiment, and FIGS. 22 and 23 show the operation status of the driving mode and the detection mode of one example of the form of the fourth embodiment.

The form shown in FIG. 21A is an example of the configuration in which two driving tines, two detection tines, and one coupling part are provided. In this configuration example, two driving tines 3a and 3b and two detection tines 4a and 4b are extended from the same side of the fixed part 5 symmetrically with the driving tines 3a and 3b inside and the detection tines 4a and 4b outside, and the tine of the coupling part 7 provided between the two driving tines 3a and 3b is extended in the same direction as that of the driving tines 3a and 3b. The support part 6 is provided on the other end of the coupling part 7 in the opposite side of the fixed part 5. The coupling part 7 may also be used as a detection tine.

The form shown in FIG. 21B is an example of the configuration in which two driving tines, one detection tine, and one coupling part are provided. In this configuration example, two driving tines 3a and 3b and one detection tine 4 are extended from the same side of the fixed part 5 with the driving tines 3a and 3b inside and the detection tine 4 outside, and the tine of the coupling part 7 provided between the two driving tines 3a and 3b is extended in the same direction as that of the driving tines 3a and 3b. The support part 6 is provided on the other end of the coupling part 7 in the opposite side of the fixed part 5. The coupling part 7 may also be used as a detection tine.

The form shown in FIG. 21C is an example of the configuration in which the coupling part is used as the detection tine and in which two driving tines and one coupling part, which functions also as the detection tine, are provided. In this configuration example, two driving tines 3a and 3b are extended from the same side of the fixed part 5, and the tine of the coupling part 7 provided between the two driving tines 3a and 3b is extended in the same direction as that of the driving tines 3a and 3b. The support part 6 is provided on the other end of the coupling part 7 in the opposite side of the fixed part 5.

In the configuration shown in FIG. 21, the external appearance of the driving tine or the detection tine is a T-shaped arrangement with the coupling part as its main component. In FIG. 21, the support part 6 has a swelled shape to provide stability. This support part may be used as a mounting part via which the piezoelectric vibrator is mounted on a structure not shown. The fixed part 5, coupling part 7, and support part 6 form the base 2.

FIGS. 22 and 23 show the operation status of the driving mode and the detection mode in the configuration example shown in FIG. 21A.

FIG. 22B and FIG. 23A show the vibration mode of the driving tines in which the driving tines vibrate in reverse phase in the direction of the plane formed by the driving tines (in-plane direction). The arrows in the figure indicate the vibration direction of the driving tines 3a and 3b in one vibration status to indicate that the driving tines vibrate in reverse phase each other in the in-plane direction.

FIG. 22C and FIG. 23B show the detection mode of the detection tines. When the angular velocity is applied, the driving tines 3a and 3b receive the Coriolis force in reverse phase in the out-of-plane direction, and turns the fixed part 5 of the base 2, from which the driving tines 3a and 3b are extended, with respect to the support part 6 that is fixed. The coupling part 7 is twisted by this force that turns the fixed part 5. The detection tines 4a and 4b, which are extended from the fixed part 5, receive the twisting operation of the coupling part 7 and vibrate in reverse phase in the out-of-plane direction. The driving tines 3a and 3b are oscillated by the twisting operation but, because they move with the fixed part in one united body, do not vibrate with respect to the fixed part.

The resonance frequency (fc) of the vibration mode in which the detection tines vibrate in the direction orthogonal to the in-plane direction, is set almost equal to the resonance frequency(fD) of the above-described vibration mode in which the driving tines 3a and 3b are moved by the twisting operation but do not vibrate. Doing so allows the twisting operation, induced in the coupling part 7 by the Coriolis force applied to the driving tines 3a and 3b, to be efficiently converted to the vibration of the detection tines 4a and 4b, thus producing a large output.

The width of the vibration of the detection tines 4a and 4b in the out-of-plane direction depends on the degree of the twist in the coupling part 7. The longer the length of the tine of the coupling part 7 is, the more easily the coupling part 7 is twisted. Therefore, increasing the length of the tine of the coupling part 7 increases the width of the vibration of the detection tines 4a and 4b, thus increasing the detection sensitivity of the angular velocity.

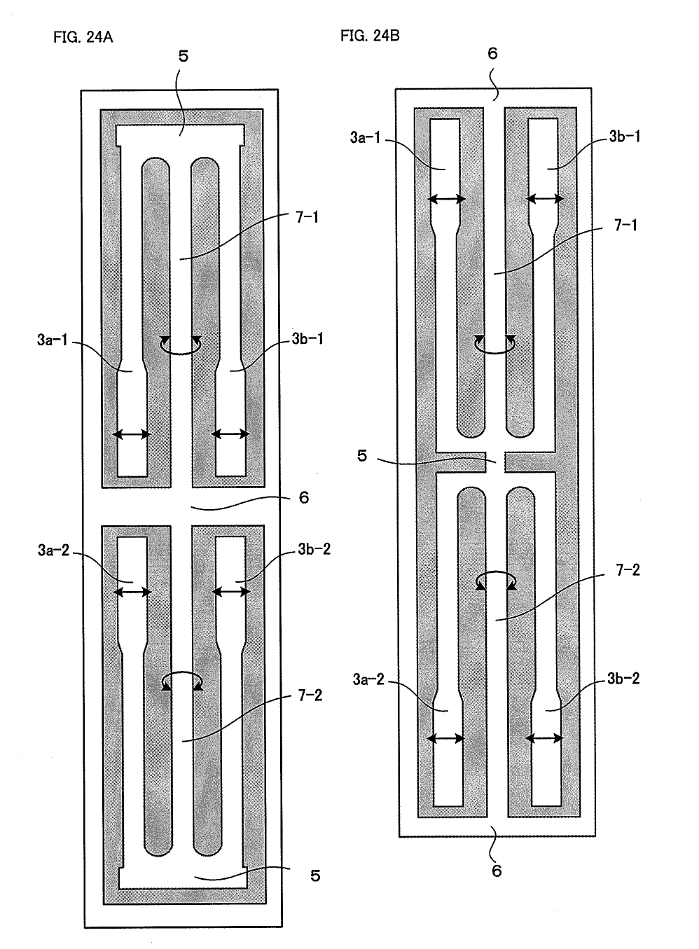

Next, the following describes another configuration example of the piezoelectric vibrator of the present invention with reference to FIG. 24. This configuration example may be configured by using two sets of the forms shown in FIG. 21C.

In the configuration example in FIG. 24A, two sets of piezoelectric vibrators are opposed with the support part 6 in common and the frame is formed by joining it to the support part 6 in the center side. In the configuration example in FIG. 24B, two sets of piezoelectric vibrators are opposed with the fixed part 5 in common and the frame is formed by joining it to the support part 6 on both end sides.

In those configuration examples, one of the piezoelectric vibrators has a coupling part 7-1, provided between driving tines 3a-1 and 3b-2, as the detection tine, and the other piezoelectric vibrator has a coupling part 7-2, provided between the driving tines 3a-2 and 3b-2, as the detection tine.

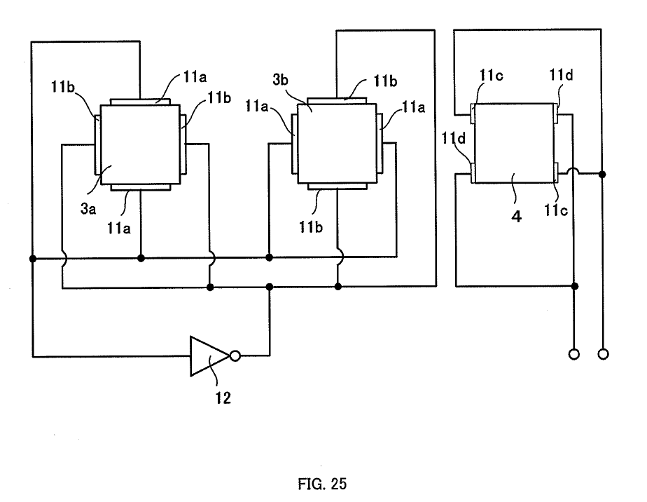

Next, referring to FIG. 25, the following describes an example of the circuits in the piezoelectric vibrator of the present invention, that is, the circuits that drive the driving tines and the circuit that outputs the detection signal from the detection tine.

FIG. 25 is a diagram showing an example of the configuration of a circuit that drives the driving tines 3a and 3b in reverse phase in the self-excited oscillation mode using a crystal as the piezoelectric vibrator.

On each of the driving tines 3a and 3b, driving electrodes 11a and driving electrodes 11b are provided on the opposed planes of the tine. On the detection tine 4, detection electrodes 11c and 11d are provided on the opposed planes of the tine. Although FIG. 17 shows the configuration in which four electrodes are provided as the detection electrodes, this configuration is exemplary only and the number of electrodes is not limited to four.

The driving circuit example shown in FIG. 25 is exemplary only, and the driving circuit is not limited to this circuit configuration.

The vibration gyro of the present invention may be configured using any of the piezoelectric vibrators having the configurations described above.

### INDUSTRIAL APPLICABILITY

An angular velocity sensor having the vibrator apparatus of the present invention is applicable to the reaction control and the navigation of movable bodies such as an aircraft, a vehicle, and so on.

1. A piezoelectric vibrator comprising:
at least two driving tines; and
at least one detection tine provided in a plane formed by said two driving tines wherein
said driving tines and said detection tine have a base on which fixed ends thereof are fixed in common,
said detection tine is provided in such a way that said detection tine does not protrude beyond an end of said base in a direction opposite to an extension direction of said driving tines, and
a resonance frequency (fa) of a vibration mode, in which said driving tines vibrate in reverse phase in a direction orthogonal to the in-plane direction, and a resonance frequency (fb) of a vibration mode, in which said driving tines vibrate in the in-plane direction, are separated in a frequency band,
whereby a vibration transmission of a leakage vibration from said driving tines to said detection tine is reduced.

2. The piezoelectric vibrator according to claim 1 wherein
said two driving tines vibrate with almost the same amplitude and
a resonance frequency (fB) of a vibration mode, in which said driving tines vibrate in the same phase in a direction orthogonal to an in-plane direction, and a resonance frequency (fc) of a vibration mode, in which said detection tine vibrates in a direction orthogonal to the in-plane direction, are set almost the same.

3. A piezoelectric vibrator comprising:
at least two driving tines; and
at least one detection tine provided in a plane formed by said two driving tines wherein
said driving tines and said detection tine have a base on which fixed ends thereof are fixed in common,
said detection tine is provided in such a way that said detection tine does not protrude beyond an end of said base in a direction opposite to an extension direction of said driving tines, and
an absolute value of a frequency difference (|fb−fc|) between a first resonance frequency (fb) of a vibration mode, in which said driving tines vibrate in reverse phase an in-plane direction, and a resonance frequency (fc) of a vibration mode, in which said detection tine vibrates in a direction orthogonal to the in-plane direction, is smaller than
an absolute value of a frequency difference (|fb−fa|) between the first resonance frequency (fb) of said driving tines and a second resonance frequency (fa) of said driving tines of a vibration mode in which said driving tines vibrate in a direction orthogonal to the in-plane direction.

4. The piezoelectric vibrator according to claim 1, wherein
a detection vibration mode is provided for outputting a detection signal from said detection tine and
in the detection vibration mode, said driving tines vibrate in the same phase in a direction orthogonal to the in-plane direction.

5. The piezoelectric vibrator according to claim 1 wherein
said base comprises a fixed part, on which said driving tines and said detection tine are fixed, and a coupling part which couples said fixed part to a support part and is extended into an extension direction of said driving tines,
said coupling part is twistable with respect to said support part, and
a resonance frequency (fD) of a vibration mode, in which said driving tines do not vibrate in a direction orthogonal to the in-plane direction but vibrate when said coupling part is twisted, is set almost the same as a resonance frequency (fc) of a vibration mode in which said detection tine vibrates in a direction orthogonal to the in-plane direction.

6. The piezoelectric vibrator according to claim 1 wherein
a detection vibration mode is provided for outputting a detection signal from said detection tine and
in the detection vibration mode, said driving tines do not vibrate in a direction orthogonal to the in-plane direction.

7. The piezoelectric vibrator according to claim 5 wherein said coupling part has a tine for coupling said base and said support part and said tine configures said detection tine.

8. The piezoelectric vibrator according to claim 1 wherein
a width of said detection tine is thinner than a width of the driving tine and
a shape of a cross section orthogonal to a longitudinal direction of said driving tines and said detection tine is a rectangle.

9. The piezoelectric vibrator according to claim 8 wherein said driving tines are a rectangle whose thickness direction is longer, or whose width direction is longer, in a cross section shape thereof.

10. The piezoelectric vibrator according to claim 1 wherein said detection tine is longer than said driving tines.

11. The piezoelectric vibrator according to claim 1 wherein said driving tines are longer than said detection tine.

12. The piezoelectric vibrator according to claim 1 wherein said detection tine has a weight at a tip thereof.

13. The piezoelectric vibrator according to claim 1 wherein said driving tines have a weight at a tip thereof.

14. The piezoelectric vibrator according to claim 12 wherein said weight is wider than a tine between said weight and said base of said driving tines or said detection tine.

15. The piezoelectric vibrator according to claim 1 wherein each of said driving tines has a groove in a longitudinal direction thereof.

16. The piezoelectric vibrator according to claim 14 wherein a cross section shape of the groove formed on said driving tines is almost H-shaped.

17. A vibration gyro comprising the piezoelectric vibrator according to claim 1 wherein
the driving tines of said piezoelectric vibrator are driven at a predetermined frequency and an external force is measured by detecting a vibration generated in said detection tine.
